(19) United States
(12) Patent Application Publication
(10) Pub. No.: US 2013/0153662 A1
(43) Pub. Date: Jun. 20, 2013

(54) Barcode Photo-image Processing System

(71) Applicant: Suma Narasa Prakash, Bangalore (IN)

(72) Inventor: Suma Narasa Prakash, Bangalore (IN)

(73) Assignee: MindTree Limited

(21) Appl. No.: 13/532,794

(22) Filed: Jun. 26, 2012

(30) Foreign Application Priority Data
Dec. 19, 2011 (IN) 4453/CHE/2011

(51) Int. Cl. G06K 7/10

(52) U.S. Cl. 235/462.07

(57) ABSTRACT

A computer implemented method and system for processing a low quality captured image of a barcode of any type having a large amount of data is provided. An image processing application on a computing device acquires the captured image of the barcode, determines the type, for example, format, shape, etc., of the barcode in the acquired image of the barcode, and creates a gray barcode image from the acquired image of the barcode by gray shading over an entirety of the acquired image of the barcode. The image processing application modularizes the created gray barcode image based on the type of the barcode and binarizes the created gray barcode image based on the type of the barcode by comparing an average gray level intensity of each of multiple grids of pixels or by comparing gray level intensities of individual pixels in the created gray barcode image, with a predetermined threshold.

### CROSS REFERENCE TO RELATED APPLICATIONS

This application claims the benefit of the following patent applications:
1. Provisional patent application number 4453/CHE/2011 titled “Barcode Photo-image Processing System”, filed on Dec. 19, 2011 in the Indian Patent Office.
2. Non-provisional patent application number 4453/CHE/2011 titled “Barcode Photo-image Processing System”, filed on Jun. 15, 2012 in the Indian Patent Office.

The specifications of the above referenced patent applications are incorporated herein by reference in their entirety.

### BACKGROUND

At present where computers are an integral part of human life with software being the essence of computers, user data plays a significant role in daily activities. There is a need to provide software applications to users that allow the users to handle a vast amount of data and perform various activities on the data in a secure manner. In this context, the usage of one-dimensional (1D) barcodes and two-dimensional (2D) barcodes to manipulate data has increased significantly from common man to corporate applications. At present, most entities have a barcode representation of data to deal with its uniqueness and security. Barcodes enable coding of information and significantly decrease work involved in data entry in comparison with that of manual data entry, thereby making data storage and retrieval faster and more accurate.

A barcode that is originally maintained as a soft copy can be decoded easily. However, barcodes are typically maintained as hard copies rather than as soft copies. That is, barcodes are typically printed on paper or on any smooth surface, instead of being stored as electronic files. A straightforward approach of transforming a hard copy of the barcode to a soft copy, for example, in the form of a barcode image involves, for example, capturing a photograph (photo) of the barcode print using an image capture device such as a mobile camera or a web camera. Decoding such soft copies of barcodes, that is, photo-images of the barcodes are marked challenging even today. Moreover, if barcodes possess large data and the photo-images of the barcodes are of low quality, decoding the photo-images of those barcodes becomes more challenging. Conventional barcode encoders allow encoding of a large amount of data. However, there are no equivalently efficient barcode decoders that can decode complex barcodes having large data and of poor quality. Conventional barcode recognition algorithms have a threshold on the complexity of the barcode, that is, on the amount of data encoded in the barcode. For example, if an algorithm appears to be successful for barcodes with 100 characters, the same algorithm may fail for barcodes with about 1000 characters or more, since the complexity of the barcode increases with respect to resolution, noise, and amount of data. As a result, barcodes are currently used only to tag web links, record messages, store small instructions, and other such small pieces of data, rather than to store large data such as employee details, organization data, resident details, etc., owing to the lack of efficient barcode decoders to decode large data. The existing methods of using barcodes are therefore limited.

In addition to the limitation on the amount of data, that is, barcode complexity, the existing barcode decoders require that the barcode images possess good image quality, good resolution, and low noise. For example, smart phones with barcode decoders require high resolution integrated cameras, having resolutions, for example, of over 5 megapixels (MP), in conjunction with additional image acquisition software. Also, the existing barcode decoders require additional hardware and software to process the barcode, which in turn incurs additional cost. There is a need for a standard and standalone photo-image processing system that can process complex barcodes with large amounts of data, without requiring additional high end software and hardware, irrespective of the degree of image quality and resolution of the barcode photo-image.

Furthermore, existing image processing techniques that employ, for example, sharpening or actual blur removal, dithering, cropping, dynamic skew rectification, etc., are often rendered ineffective for photo-images of barcodes, as these image processing techniques corrupt a standard format or encoded data of the barcode image and also cause loss of data in the barcode image. Therefore, there is a need for a photo-image processing system that does not corrupt the encoded data in the barcode image, does not distort the standard format of the barcode, and does not cause loss of data in the barcode image during processing of the barcode image.

Image quality typically depends on the following aspects, for example, resolution of an image and additional noise, lighting, etc. The noise in the photo-images of barcodes affects the performance of existing barcode decoders. For instance, a 5 MP photo-image with noise is not equivalent to a 2 MP photo-image with noise, although both are said to be of low quality due to the presence of noise. Therefore, there is a need for a photo-image processing system that provides noise resistance, such that the barcode decoder is able to decode a low resolution barcode image.

Hence, there is a long felt but unresolved need for a low cost computer implemented method and system that processes a captured image or a photo-image of a complex barcode of any type, having low image quality and noise, with the barcode encoding a large amount of data, thereby enabling any barcode decoder to decode such a complex barcode and providing a usage scope from home to industry. Furthermore, there is a need for a computer implemented method and system that processes a captured image or a photo-image of a complex barcode encoding a large amount of data, without corrupting the encoded data, without distorting the format of the barcode, and without causing loss of data in the barcode image.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above stated need for processing a captured image or photo-image of a complex barcode of any type, having low image quality and noise, with the barcode encoding a large amount of data, for example, employee details, organization data, resident details, confidential information, etc., of over 1000 characters, thereby enabling a barcode decoder to decode the complex barcode when fed with the processed barcode image and providing a usage scope from home to industry. The computer implemented method and system disclosed herein processes a captured image or a photo-image of a hard copy of a complex barcode encoding a large amount of data, without corrupting the encoded data, without distorting the format of the barcode, without causing loss of data in the barcode image, without requiring any additional high end software, and without requiring any hardware, for example, optical barcode readers, etc., and irrespective of the degree of image quality and resolution of the barcode photo-image.

The computer implemented method and system disclosed herein also provides noise resistance for enabling a barcode decoder to decode a low resolution photo-image of the barcode. The computer implemented method and system disclosed herein supports any barcode decoder and allows enhanced decoding by overcoming the limitations of image quality and amount of data of the barcode decoder. The support for large amount of data provided by the computer implemented method and system disclosed herein prominently changes the role of barcodes in the present world.

An image processing application is provided on a computing device. The image processing application acquires the captured image of the barcode, for example, from image files stored locally on the computing device or directly from an image capture device. The barcode in the captured image is of multiple types and comprises a large amount of data. The data in the barcode comprises, for example, one or more of textual content, image content, graphical content, etc., and any combination thereof. The captured image of the barcode is, for example, of a low quality with respect to image resolution, noise, and distortion.

The image processing application determines the type of the barcode in the acquired image of the barcode. The type of the barcode comprises, for example, a shape of the barcode, a format of the barcode, etc., or a combination thereof. The shape of the barcode is, for example, a quadra-shape, a linear shape, etc. The format of the barcode is, for example, a one-dimensional (1D) barcode format, a two-dimensional (2D) barcode format, etc. The image processing application creates a gray barcode image from the acquired image of the barcode by gray shading over an entirety of the acquired image of the barcode.

In an embodiment, the image processing application scales over the entirety of the acquired image of the barcode to create a scaled barcode image, prior to the creation of the gray barcode image. In this embodiment, the image processing application creates the gray barcode image from the scaled barcode image by gray shading over an entirety of the scaled barcode image.

The image processing application modularizes the created gray barcode image based on the determined type of the barcode. For example, the image processing application modularizes the created gray barcode image when the determined type of the barcode is of a quadra-shape. In an embodiment, the image processing application configures a grid size for the modularization of the created gray barcode image based on predetermined criteria comprising, for example, a degree of blur, a type of the barcode such as a quadra-shaped barcode that grows in two dimensions, etc. The image processing application binarizes the created gray barcode image based on the determined type of the barcode by comparing an average gray level intensity of each of multiple grids of pixels in the created gray barcode image or by comparing a gray level intensity of each of the individual pixels in the created gray barcode image, with a predetermined threshold. In an example, the image processing application binarizes the modularized gray barcode image when the determined type of the barcode is of a quadra-shape that grows in two dimensions. In another example, the image processing application binarizes the created gray barcode image when the determined type of the barcode is of a linear shape that grows in one dimension.

In an embodiment, the image processing application computes a gray level intensity of each of the pixels in the created gray barcode image and compares the computed gray level intensity with a predetermined threshold based on the determined type of the barcode, for example, when the determined type of the barcode is of a linear shape that grows in one dimension. In another embodiment, the image processing application computes an average gray level intensity of each of the grids of the pixels in the created gray barcode image and compares the computed average gray level intensity with a predetermined threshold based on the determined type of the barcode, for example, when the determined type of the barcode is of a quadra-shape that grows in two dimensions. The image processing application then binarizes the created gray barcode image based on the comparison of the computed average gray level intensity of each of the grids of pixels in the created gray barcode image with the predetermined threshold depending on the determined type of the barcode or based on the comparison of the computed gray level intensity of each of the pixels in the created gray barcode image with the predetermined threshold depending on the determined type of the barcode.

In an embodiment, the image processing application preserves a rest zone around the barcode during the modularization and the binarization of the created gray barcode image over the entirety of the created gray barcode image. Moreover, the image processing application preserves start points and end points of the barcode during the modularization and the binarization of the created gray barcode image over the entirety of the created gray barcode image. Furthermore, the image processing application retains the format and the shape of the barcode for reducing distortion of the format and the shape of the barcode. Furthermore, the image processing application retains the large amount of data in the barcode for preventing corruption of the large amount of data in the barcode.

The modularization and binarization of the created gray barcode image enables decoding of the captured image of the barcode having low image resolutions and decoding of the barcode having a large amount of data in one or more barcode formats, and provides resistance to noise and distortion in the captured image of the barcode. The noise resistance provided by the computer implemented method and system disclosed herein enables efficient decoding, since resolution of the photo-image of the barcode affects decoding performance with the elimination of noise. As a result, the noise resistance for a photo with resolutions of about 5 megapixels (MP) and above substantially differs from noise resistance for a photo with 1.3 MP to 2 MP resolutions.

The computer implemented method and system disclosed herein eliminates the need for a barcode scanner or any other processing device, eliminates the need for additional image acquisition software, processes multiple barcode formats, for example, 1D and 2D barcodes for subsequent decoding, processes low quality photo-images of barcode prints, for example, low resolution photo-images of about 1.3 MP and 2 MP with acceptable noise resistance for decoding, and processes photo-images of barcodes with large data having, for example, over 1000 characters for decoding. The computer implemented method and system disclosed herein also supports any type of encoded data, for example, alphabets, numerals, special characters, etc., and supports graphical barcodes containing images, textual content, etc. The computer implemented method and system disclosed herein processes and reads low quality photo-images of barcode prints encoded with a large amount of data, with a usage scope from home to industry.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for processing a captured image of a barcode.

FIGS. 2A-2K exemplarily illustrate standard barcode formats that can be processed by an image processing application of the computer implemented method and system disclosed herein.

FIG. 3 exemplarily illustrates a skewed barcode that can be processed by the image processing application of the computer implemented method and system disclosed herein.

FIG. 4 exemplarily illustrates a computer implemented system for processing a captured image of a barcode of any type.

FIG. 5 exemplarily illustrates the architecture of a computer system employed by an image processing application for processing a captured image of a barcode of any type.

FIG. 6 exemplarily illustrates an algorithm for processing quadra-shaped barcodes.

FIG. 7 exemplarily illustrates an algorithm for processing linear shaped barcodes.

FIG. 8A exemplarily illustrates a pixel-level input image of a quadra-shaped barcode.

FIG. 8B exemplarily illustrates a scaled image of a quadra-shaped barcode.

FIG. 8C exemplarily illustrates a grid in the input image of a quadra-shaped barcode.

FIG. 8D exemplarily illustrates a grid in a gray barcode image of a quadra-shaped barcode.

FIGS. 8E-8F exemplarily illustrate binarized grids generated based on a comparison of a computed average gray level intensity of a grid in the gray barcode image of a quadra-shaped barcode, with a predetermined threshold.

FIG. 9A exemplarily illustrates a pixel-level input image of a linear shaped barcode.

FIG. 9B exemplarily illustrates a scaled image of a linear shaped barcode.

FIG. 9C exemplarily illustrates a pixel in the input image of a linear shaped barcode.

FIG. 9D exemplarily illustrates a pixel in a gray barcode image of a linear shaped barcode.

FIGS. 9E-9F exemplarily illustrate binarized pixels generated based on a comparison of a computed gray level intensity of a pixel in the gray barcode image of a linear shaped barcode, with a predetermined threshold.

FIG. 10 exemplarily illustrates an algorithm for processing a captured image of a barcode for a selected barcode format.

FIG. 11 exemplarily illustrates a photo-image of a quick response code with low image quality and a large amount of encoded data.

FIGS. 12A-12H exemplarily illustrate screenshots of a graphical user interface provided by the image processing application for processing a captured image of a barcode.

FIG. 13 exemplarily illustrates image-by-image processing of a captured image of a complex barcode for subsequent decoding of the processed barcode.

FIGS. 14A-14D exemplarily illustrate a flow chart comprising the steps for processing a captured image of a barcode.

### DETAILED DESCRIPTION OF THE INVENTION

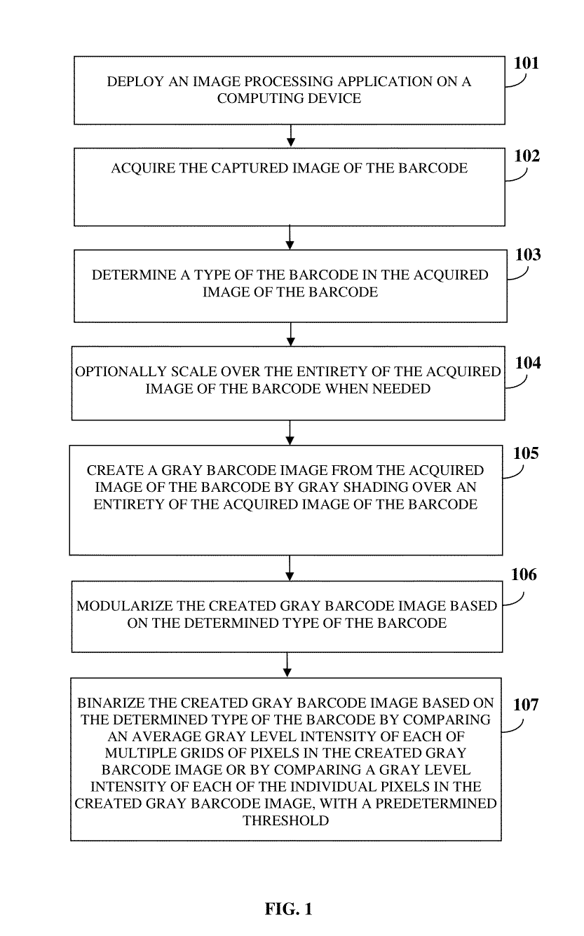

FIG. 1 illustrates a computer implemented method for processing a captured image of a barcode. The computer implemented method disclosed herein employs a computer system comprising at least one processor communicatively coupled to a non-transitory computer readable storage medium that stores instructions executable by at least one processor, where at least one processor is configured to implement the method disclosed herein. An image processing application is deployed 101 on a computing device, for example, a personal computer (PC), a networked computer, a mobile computing device, a tablet computer, a cellular phone, a personal digital assistant, an image capture device, etc. The image processing application acquires 102 the captured image of the barcode, for example, from image files stored locally on the computing device or directly from an image capture device. The barcode in the captured image is of multiple types and comprises a large amount of data, for example, employee details, organization data, resident details, confidential information, etc., of more than 1000 characters. The data in the barcode comprises, for example, textual content such as alphabets, numbers, symbols, etc., image content, graphical content, or any combination thereof. The captured image of the barcode is, for example, of a low quality with respect to image resolution, noise, and distortion.

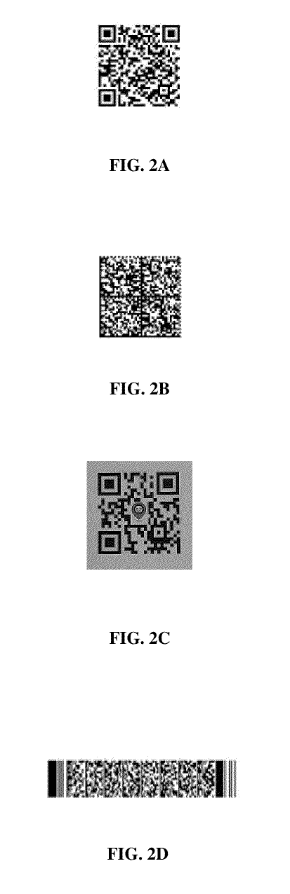

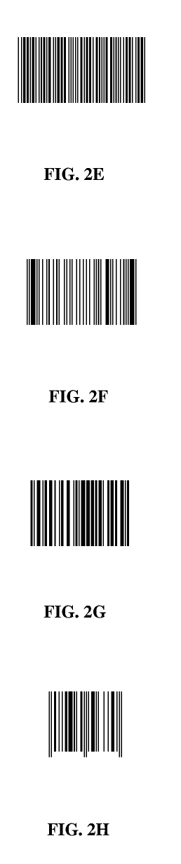

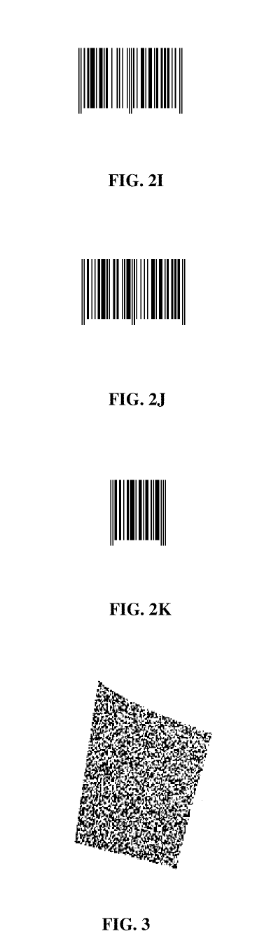

The image processing application determines 103 a type of the barcode in the acquired image of the barcode. The type of the barcode comprises, for example, a shape of the barcode, a format of the barcode, etc., as exemplarily illustrated in FIGS. 2A-2K. The barcode is, for example, a quadra-shaped barcode as exemplarily illustrated in FIGS. 2A-2C, a linear shaped barcode as exemplarily illustrated in FIGS. 2D-2K, etc. The format of the barcode is, for example, a one-dimensional (1D) barcode format, a two-dimensional (2D) barcode format, etc., as exemplarily illustrated in FIGS. 2A-2K. In an embodiment, the image processing application optionally scales 104 over the entirety of the acquired image of the barcode to create a scaled barcode image. The image processing application analyzes the acquired image of the barcode and dynamically determines the need for scaling. For example, the image processing application chooses to scale the input image if recognition of the un-scaled input image is not successful, for example, due to the size of the input image being too small or too big. Therefore, the image processing application dynamically scales the input image if the input image is too small or too big.

The image processing application creates 105 a gray barcode image from the acquired image of the barcode or the scaled barcode image by gray shading over an entirety of the acquired image of the barcode or the scaled barcode image respectively. The image processing application modularizes 106 the created gray barcode image based on the determined type of the barcode. For example, the image processing application modularizes the created gray barcode image when the determined type of the barcode is of a quadra-shape. The image processing application modularizes the created gray barcode image by partitioning the created gray barcode image into grids or groups of pixels to enable efficient processing of a complex barcode having a large amount of data. In an embodiment, the image processing application configures a grid size of, for example, 3*3 pixels for the modularization of the created gray barcode image based on predetermined criteria comprising, for example, a degree of blur, a shape of the barcode, etc.

The image processing application binarizes 107 the created gray barcode image based on the determined type of the barcode by comparing an average gray level intensity of each of multiple grids of pixels in the created gray barcode image or by comparing a gray level intensity of each of the individual pixels in the created gray barcode image, with a predetermined threshold. For example, the image processing application binarizes the modularized gray barcode image when the determined type of the barcode is of a quadra-shape. In another example, the image processing application binarizes the created gray barcode image, without modularization, when the determined type of the barcode is of a linear shape.

For binarization, the image processing application computes a gray level intensity of each of the pixels in the created gray barcode image and compares the computed gray level intensity with a predetermined threshold based on the determined type of the barcode, for example, when the determined type of the barcode is of a linear shape as disclosed in the detailed description of FIG. 7. In an embodiment, the image processing application computes an average gray level intensity of each of the grids of pixels in the created gray barcode image and compares the computed average gray level intensity with a predetermined threshold based on the determined type of the barcode, for example, when the determined type of the barcode is of a quadra shape as disclosed in the detailed description of FIG. 6. That is, the created gray barcode image is binarized based on a comparison of a computed average gray level intensity of each of the grids of pixels in the created gray barcode image or a computed gray level intensity of each of the individual pixels in the created gray barcode image with a predetermined threshold depending on the type of the barcode.

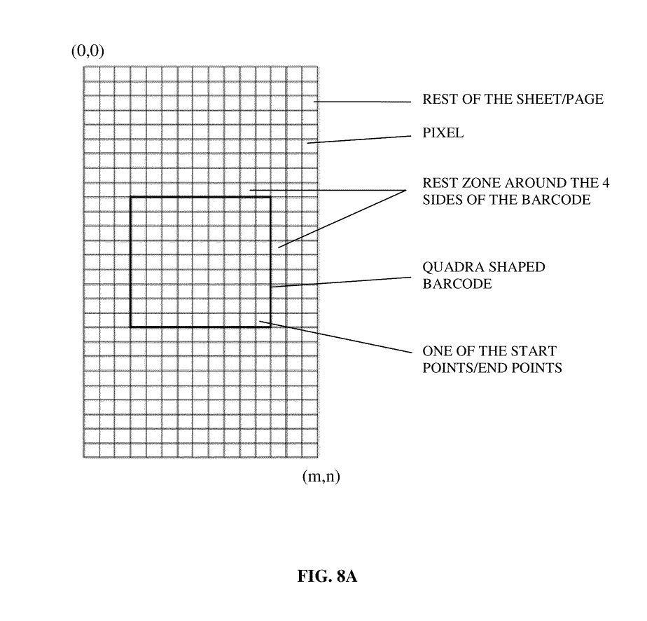

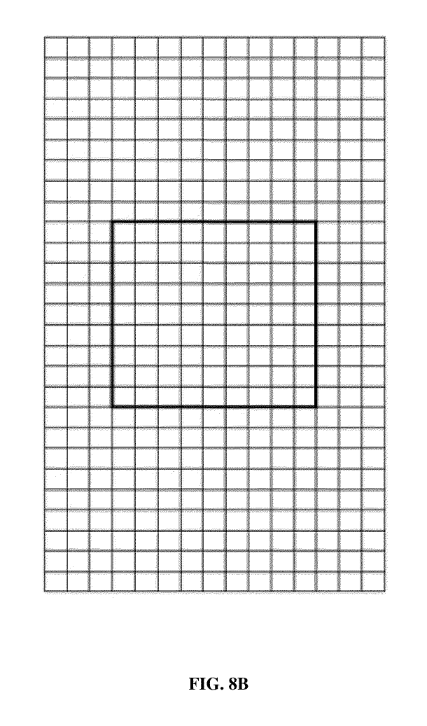

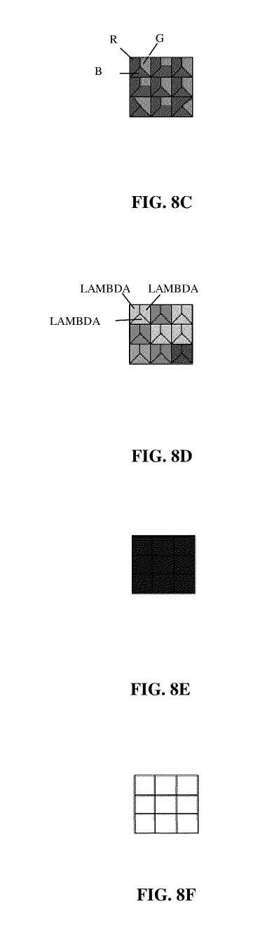

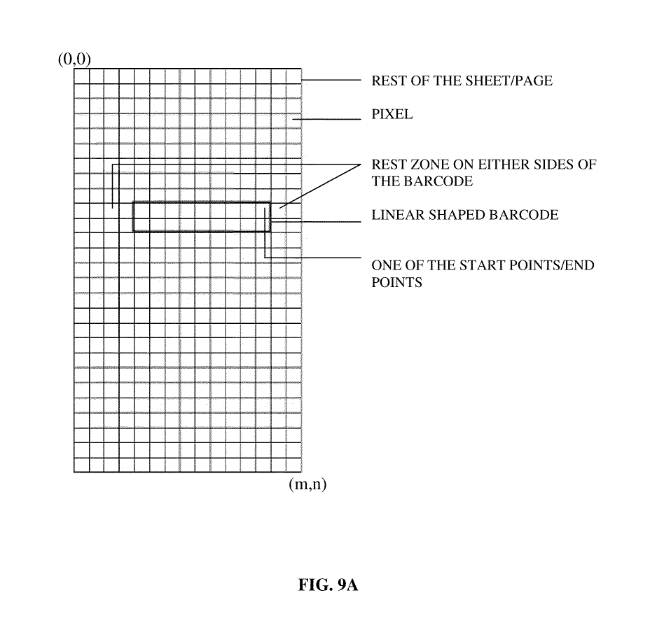

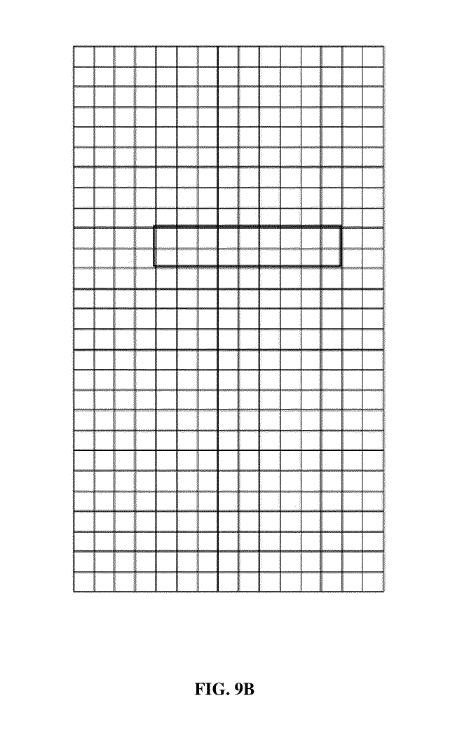

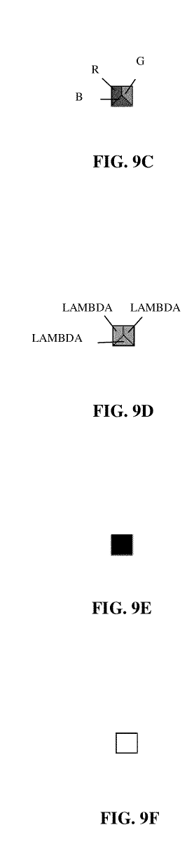

In an embodiment, the image processing application preserves a rest zone around the barcode during the modularization and the binarization of the created gray barcode image over the entirety of the created gray barcode image as exemplarily illustrated in FIG. 8A and FIG. 9A. The image processing application preserves the rest zone around the barcode by processing the entire image, that is, the entire sheet containing the barcode, since cropping the image to contain only the barcode distorts the rest zone of the barcode.

Moreover, the image processing application preserves start points and end points of the barcode during the modularization and the binarization of the created gray barcode image over the entirety of the created gray barcode image as exemplarily illustrated in FIG. 8A and FIG. 9A. The image processing application preserves the start points and the end points of the barcode by processing the entire image, that is, the entire sheet containing the barcode, since cropping the image to contain only the barcode distorts the start points and the end points of the barcode. Furthermore, the image processing application retains the format and the shape of the barcode for reducing distortion of the format and the shape of the barcode. The image processing application retains the format and the shape of the barcode by processing the entirety of the image, that is, the entire sheet containing the barcode, since cropping the image to contain only the barcode distorts the format and the shape of the barcode. Furthermore, the image processing application retains a large amount of data in the barcode for preventing corruption of the large amount of data in the barcode. The image processing application retains the large amount of data in the barcode by processing the entirety of the image, that is, the entire sheet containing the barcode. Processing over the entirety of the captured image of the barcode provides enhanced flexibility in retaining the characteristics of a photo-image of a complex barcode, that is, a barcode with a large amount of data. Therefore, by processing the entirety of the image, that is, the entire sheet containing the barcode, the image processing application controls the practical dependencies inherent during the capture of the photo-image of the barcode and maintains accuracy in processing the photo-image of the barcode, without causing loss of data in the barcode.

FIGS. 2A-2K exemplarily illustrate standard barcode formats that can be processed by the image processing application of the computer implemented method and system disclosed herein. As exemplarily illustrated in FIGS. 2A-2K, the image processing application processes barcodes of different barcode types, for example, quadra-shaped barcodes such as a quick response (QR) code, a data matrix code, and graphical barcodes comprising images, textual content, etc., and linear shaped barcodes such as a portable data file 417 (PDF417) barcode and 1D barcodes. Examples of 2D barcodes comprise a quick response (QR) code as exemplarily illustrated in FIG. 2A, a data matrix code as exemplarily illustrated in FIG. 2B, a graphical barcode as exemplarily illustrated in FIG. 2C, a PDF417 barcode as exemplarily illustrated in FIG. 2D, etc. Examples of 1D barcodes comprise, a Code 39 barcode as exemplarily illustrated in FIG. 2E, a Code 93 barcode as exemplarily illustrated in FIG. 2F, a Code 128 barcode as exemplarily illustrated in FIG. 2G, different forms of an international article number barcode, for example, an EAN-8 barcode as exemplarily illustrated in FIG. 2H, an EAN-13 barcode as exemplarily illustrated in FIG. 2I, etc., different forms of a universal product code (UPC), for example, a UPC-A barcode as exemplarily illustrated in FIG. 2J and a UPC-E barcode as exemplarily illustrated in FIG. 2K, etc.

Examples of quadra-shaped barcodes comprise a quick response (QR) code as exemplarily illustrated in FIG. 2A, a data matrix code as exemplarily illustrated in FIG. 2B, and a graphical barcode as exemplarily illustrated in FIG. 2C. Examples of linear shaped barcodes comprise a portable data file 417 (PDF417) barcode as exemplarily illustrated in FIG. 2D, a Code 39 barcode as exemplarily illustrated in FIG. 2E, a Code 93 barcode as exemplarily illustrated in FIG. 2F, a Code 128 barcode as exemplarily illustrated in FIG. 2G, an EAN-8 barcode as exemplarily illustrated in FIG. 2H, an EAN-13 barcode as exemplarily illustrated in FIG. 2I, a UPC-A barcode as exemplarily illustrated in FIG. 2J, and a UPC-E barcode as exemplarily illustrated in FIG. 2K. The photo-image of the barcode that serves as the input image to the image processing application can be in any of the following example file formats: bitmap (*.bmp), device independent bitmap (*.dib), joint photographic experts group (JPEG) (*.jpg), JPEG (*.jpeg), JPEG (*.jpe), JPEG file interchange format (*.jfif), a graphics interchange format (GIF) (*.gif), portable network graphics (PNG) (*.png), tagged image file format (TIFF) (*.tif), TIFF (*.tiff), etc.

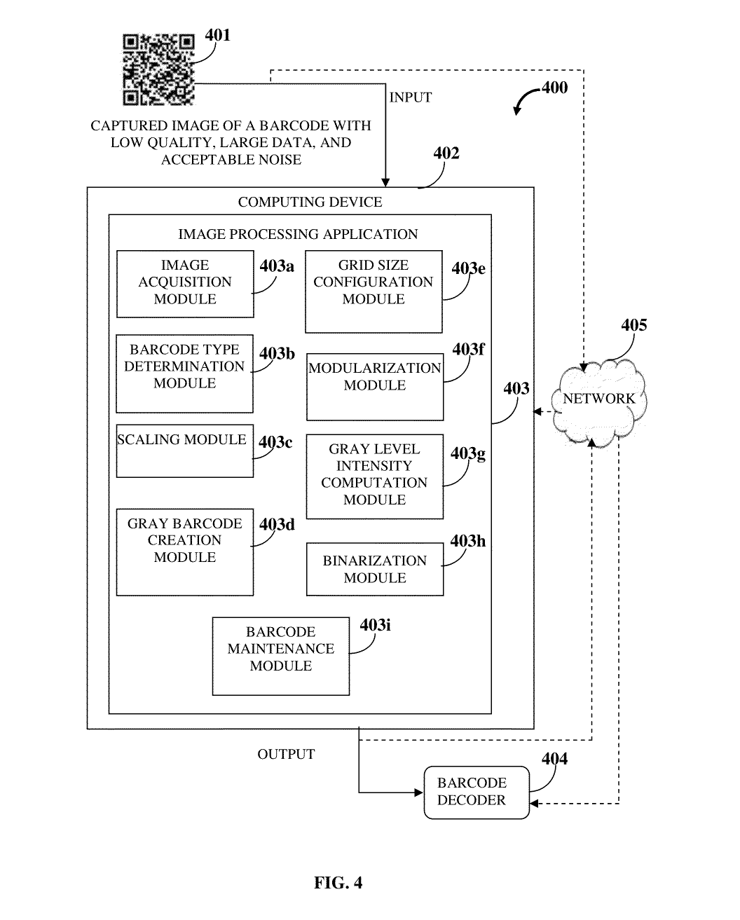

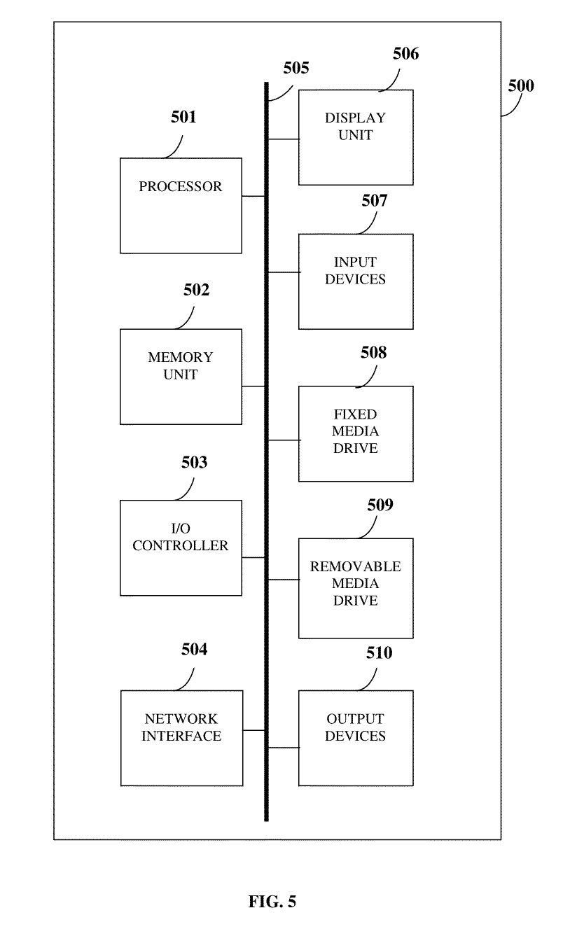

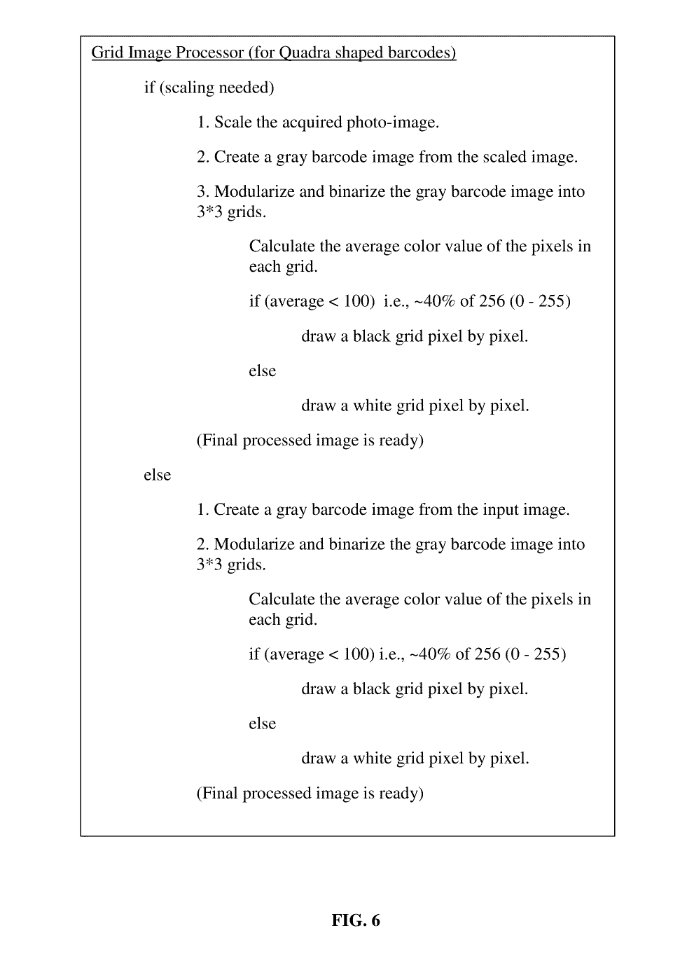

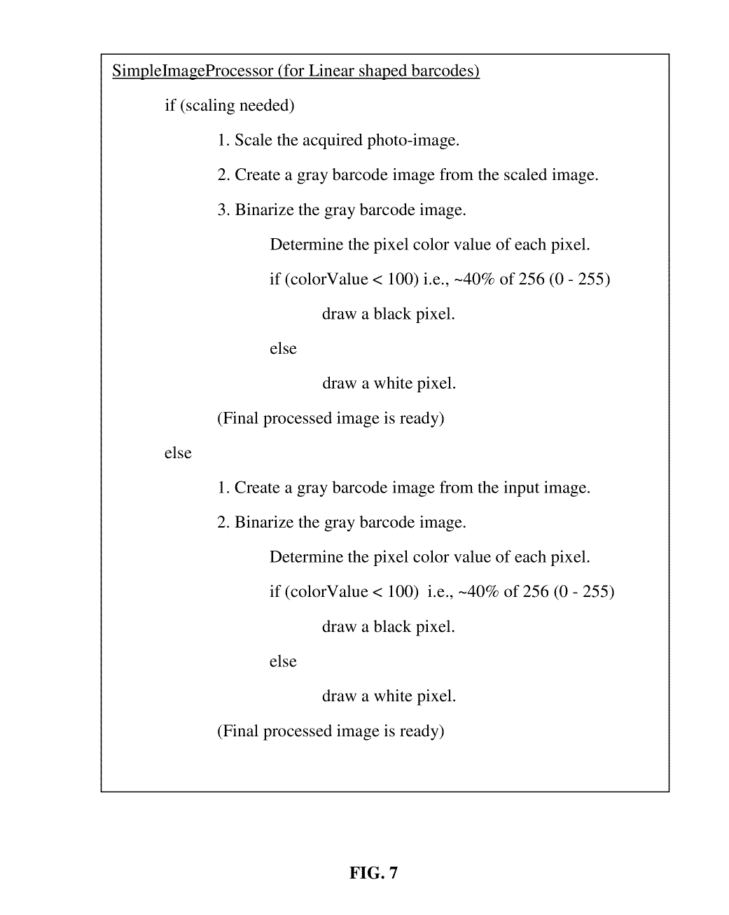

FIG. 3 exemplarily illustrates a skewed barcode that can be processed by the image processing application of the computer implemented method and system disclosed herein. There are practical dependencies inherent during the capture of a photograph (photo) of a hard copy of a barcode by a user, for example, improper dynamic skew of the barcode, which makes skew rectification infeasible. The image processing application disclosed herein handles the skew by processing the entirety of the captured image of the barcode, thereby retaining a rest zone, start points and end points, the format, the shape, and large amount of data of the barcode. By processing the entire image of the barcode, the image processing application maintains accuracy in processing the barcode. Based on the degree or the amount of skew, the barcode image, if readable, can be decoded using redundant bits embedded in the barcode.

FIG. 4 exemplarily illustrates a computer implemented system 400 for processing a captured image 401 of a barcode of any type. The captured image 401 of the barcode is, for example, of low quality and comprises a large amount of data and acceptable noise. An image 401, for example, a color photograph (photo) of a barcode print, is captured using a photo capturing device (not shown), for example, a camera such as a web camera, a mobile camera, a digital camera, etc. As part of the basic barcode capture requisites, the distance between the camera and the barcode print should be nominal, for example, about 10 inches to about 15 inches, which is neither too far nor too near. The barcode print should be held flat and straight in front of a pinhole of the camera, that is, the barcode print should not be skewed or folded. The photo capturing device is configured to provide suitable lighting for the barcode print which improves the efficiency of recognition. These basic barcode capture requisites are analogous to those of barcode scanners. The captured image 401, for example, a barcode photo-image is considered to be in a readable form if captured according to these barcode capture requisites.

The resolution of the captured image 401 is configured, for example, to about 2 megapixels (MP). The computer implemented system 400 disclosed herein also referred to as the “barcode photo-image processing system” comprises the image processing application 403 deployed on a computing device 402. The computing device 402 is, for example, a personal computer, a laptop, a mobile communication device, a tablet computing device, a personal digital assistant, a cellular phone, etc. The captured input image 401 is input to the image processing application 403 deployed on the computing device 402. In an embodiment, the captured image 401 is input to the image processing application 403 on a standalone computing device 402. In another embodiment, the captured image 401 is input to the image processing application 403 on a networked computing device 402 via a network 405. The network 405 is, for example, a Bluetooth® communication network, a network that implements Wi-Fi® of the Wireless Ethernet Compatibility Alliance, Inc., an ultra-wideband communication network (UWB), a wireless universal serial bus (USB) communication network, a ZigBee® communication network, a general packet radio service (GPRS) network, a mobile telecommunication network such as a global system for mobile (GSM) communications network, a code division multiple access (CDMA) network, a third generation (3G) mobile communication network, etc., a local area communication network, an internet connection network, an infrared communication network, etc.

The image processing application 403 performs various processing techniques on the input image 401 and generates a final processed output image. The output image generated by the image processing application 403 is fed to a barcode decoder 404 for successful decoding of the data in the barcode. The image processing in accordance with the computer implemented method and system 400 disclosed herein and the decoding process takes, for example, less than a second. In an embodiment, the output image is transmitted to a standalone barcode decoder 404, for example, via a wired mode of communication, a wireless mode of communication, or a combination thereof. In another embodiment, the output image is transmitted to the barcode decoder 404 via the network 405. In another embodiment, the barcode decoder 404 is incorporated in the computing device 402 along with the image processing application 403. If the input image 401, without any processing, is input directly to the barcode decoder 404, the barcode decoder 404 may not be able to successfully decode the barcode. The image processing application 403 disclosed herein enables the barcode decoder 404 to efficiently decode the barcode by overcoming the limitations of image quality and amount of data in the barcode, of the barcode decoder 404. The image processing application 403 comprises an image acquisition module 403a, a barcode type determination module 403b, a gray barcode creation module 403d, a modularization module 403f, a gray level intensity computation module 403g, and a binarization module 403h.

The image acquisition module 403a acquires the captured image 401 of the barcode, for example, from locally stored image files or directly from an image capture device (not shown). The barcode in the captured image 401 comprises a large amount of data in one or more barcode formats, for example, a one-dimensional (1D) barcode format or a two-dimensional (2D) barcode format. The captured image 401 is, for example, of low quality with respect to image resolution, noise, and distortion. The barcode type determination module 403b determines a type of the barcode, for example, the shape and the format of the barcode, in the acquired image of the barcode. In an embodiment, the image processing application 403 further comprises a scaling module 403c for optionally scaling the entirety of the acquired image of the barcode to create a scaled image of the barcode prior to the creation of the gray barcode image.

The gray barcode creation module 403d creates a gray barcode image from the acquired image of the barcode or from the scaled image of the barcode by gray shading over an entirety of the acquired image of the barcode or the scaled image of the barcode respectively. The modularization module 403f modularizes the created gray barcode image based on the determined type of the barcode. For example, the modularization module 403f modularizes the created gray barcode image when the determined type of the barcode is, for example, of a quadra-shape. In an embodiment, the image processing application 403 further comprises a grid size configuration module 403e for configuring a grid size for the modularization of the created gray barcode image based on predetermined criteria comprising, for example, a degree of blur, a type of the barcode such as a quadra-shaped barcode that grows in two dimensions, etc.

For binarization, the gray level intensity computation module 403g computes, for example, a gray level intensity of each pixel in the created gray barcode image and compares the computed gray level intensity with a predetermined threshold based on the determined type of the barcode, for example, when the determined type of the barcode is of a linear shape. In another example, the gray level intensity computation module 403g computes the average gray level intensity of each of multiple grids of pixels in the created gray barcode image and compares the computed average gray level intensity with a predetermined threshold based on the determined type of the barcode, for example, when the determined type of the barcode is of a quadra-shape.

In an embodiment, the binarization module 403h binarizes the modularized gray barcode image based on the comparison of the computed average gray level intensities of the grids of pixels in the modularized gray barcode image with the predetermined threshold depending on the determined type of the barcode. In another embodiment, the binarization module 403h binarizes the created gray barcode image based on the comparison of the computed gray level intensity of each of the pixels with the predetermined threshold depending on the determined type of the barcode. In an example, the binarization module 403h binarizes the modularized gray barcode image when the determined type of the barcode is of a quadra-shape. In another example, the binarization module 403h binarizes the created gray barcode image, without modularization, when the determined type of the barcode is of a linear shape.

In an embodiment, the image processing application 403 further comprises a barcode maintenance module 403i for preserving a rest zone around the barcode during the modularization and the binarization of the created gray barcode image over the entirety of the created gray barcode image. Furthermore, the barcode maintenance module 403i preserves start points and end points of the barcode during the modularization and binarization of the created gray barcode image over the entirety of the created gray barcode image. The barcode maintenance module 403i also retains the format and the shape of the barcode for reducing distortion of the format and the shape of the barcode by processing the entire gray barcode image, that is, the entire sheet containing the barcode. The barcode maintenance module 403i also retains the large amount of data in the barcode by processing the entire image, that is, the entire sheet containing the barcode, for preventing corruption of the large amount of data in the barcode.

FIG. 5 exemplarily illustrates the architecture of a computer system 500 employed by the image processing application 403 for processing a captured image 401 of a barcode of any type. The image processing application 403 on the computing device 402 exemplarily illustrated in FIG. 4 employs the architecture of the computer system 500 exemplarily illustrated in FIG. 5. The computer system 500 comprises, for example, a processor 501, a memory unit 502 for storing programs and data, an input/output (I/O) controller 503, a network interface 504, a data bus 505, a display unit 506, input devices 507, a fixed media drive 508, a removable media drive 509 for receiving removable media, output devices 510, etc.

The processor 501 is an electronic circuit that executes computer programs. The memory unit 502 stores programs, applications, and data. For example, the image acquisition module 403a, the barcode type determination module 403b, the scaling module 403c, the gray barcode creation module 403d, the grid size configuration module 403e, the modularization module 403f, the gray level intensity computation module 403g, the binarization module 403h, and the barcode maintenance module 403i of the image processing application 403 are stored in the memory unit 502 of the computer system 500. The memory unit 502 is, for example, a random access memory (RAM) or another type of dynamic storage device that stores information and instructions for execution by the processor 501. The memory unit 502 also stores temporary variables and other intermediate information used during execution of the instructions by the processor 501. The computer system 500 further comprises a read only memory (ROM) or another type of static storage device that stores static information and instructions for the processor 501.

In an example, the computer system 500 of the computer implemented system 400 also referred to as the “barcode photo-image processing system” communicates with other interacting devices, for example, the barcode decoder 404, a photo capturing device (not shown), etc., through the network interface 504. In another example, the computer system 500 of the barcode photo-image processing system 400 communicates with other interacting devices, for example, the barcode decoder 404 which is stored in the memory unit 502 of the computer system 500, a photo capturing device (not shown), etc., through the network interface 504. The network interface 504 comprises, for example, a Bluetooth® interface, an infrared (IR) interface, an interface that implements Wi-Fi® of the Wireless Ethernet Compatibility Alliance, Inc., a universal serial bus (USB) interface, a local area network (LAN) interface, a wide area network (WAN) interface, etc. The I/O controller 503 controls input actions and output actions performed by the barcode photo-image processing system 400. The data bus 505 permits communication between the modules, for example, 403a, 403b, 403c, 403d, 403e, 403f, 403g, 403h, 403i, etc., of the image processing application 403 and between the image processing application 403 and the barcode decoder 404.

The display unit 506 displays the processed output image of the barcode. The display unit 506, for example, displays icons, user interface elements such as text fields, menus, display interfaces, etc., for allowing the user, for example, to upload the image 401 of the barcode. The input devices 507 are used for inputting data, for example, an image of the barcode, a type of barcode, etc., into the computer system 500. The input devices 507 are, for example, a keyboard such as an alphanumeric keyboard, a joystick, a computer mouse, a touch pad, a light pen, a digital pen, a microphone, a digital camera, etc. The output devices 510 output the results of the actions computed by the image processing application 403, for example, to a user of the computing device 402. For example, the image processing application 403 notifies a user of error messages generated on unsuccessful decoding of the image of the barcode through a pop-up window on the output device 510, such as a display unit 506 of the computing device 402.

Computer applications and programs are used for operating the computer system 500. The programs are loaded onto the fixed media drive 508 and into the memory unit 502 of the computer system 500 via the removable media drive 509. In an embodiment, the computer applications and programs may be loaded directly via a network 405, for example, a ^{WiFi}® network. Computer applications and programs are executed by double clicking a related icon displayed on the display unit 506 using one of the input devices 507.

The computer system 500 employs an operating system for performing multiple tasks. The operating system is responsible for management and coordination of activities and sharing of resources of the computer system 500. The operating system further manages security of the computer system 500, peripheral devices connected to the computer system 500, and network connections. The operating system employed on the computer system 500 recognizes, for example, inputs provided by a user using one of the input devices 507, the output display, files, and directories stored locally on the fixed media drive 508, for example, a hard drive. The operating system on the computer system 500 executes different programs using the processor 501. The processor 501 retrieves the instructions for executing the modules, for example, 403a, 403b, 403c, 403d, 403e, 403f, 403g, 403h, 403i, etc., of the image processing application 403. A program counter determines the location of the instructions in the memory unit 502. The program counter stores a number that identifies a current position in a program of each of the modules, for example, 403a, 403b, 403c, 403d, 403e, 403f, 403g, 403h, 403i, etc., of the image processing application 403.

The instructions fetched by the processor 501 from the memory unit 502 after being processed are decoded. The instructions are placed in an instruction register in the processor 501. After processing and decoding, the processor 501 executes the instructions. For example, the image acquisition module 403a defines instructions for acquiring the captured image 401 of the barcode. The barcode type determination module 403b defines instructions for determining the type of the barcode in the acquired image of the barcode. The scaling module 403c defines instructions for scaling the entirety of the acquired image of the barcode. The gray barcode creation module 403d defines instructions for creating a gray barcode image from the acquired image of the barcode or the scaled image of the barcode. The modularization module 403f defines instructions for modularizing the created gray barcode image based on the determined type of the barcode. For example, the modularization module 403f defines instructions for modularizing the created gray barcode image when the determined type of the barcode is of a quadra-shape. The grid size configuration module 403e defines instructions for configuring the grid size for the modularization of the created gray barcode image based on predetermined criteria.

The gray level intensity computation module 403g defines instructions for computing a gray level intensity of each pixel in the created gray barcode image and for comparing the computed gray level intensity of each of the individual pixels with a predetermined threshold based on the determined type of the barcode, for example, when the determined type of the barcode is of a linear shape. The gray level intensity computation module 403g defines instructions for computing an average gray level intensity of each of multiple grids of pixels in the created gray barcode image and for comparing the computed average gray level intensity with a predetermined threshold based on the determined type of the barcode, for example, when the determined type of the barcode is of a quadra-shape. The binarization module 403h defines instructions for binarizing the modularized gray barcode image based on the comparison of the computed average gray level intensity of each of the grids of pixels in the modularized gray barcode image with the predetermined threshold depending on the determined type of the barcode or based on the comparison of the computed gray level intensity of each of the pixels in the created gray barcode image with the predetermined threshold depending on the determined type of the barcode. The binarization module 403h defines instructions for binarizing the modularized gray barcode image when the determined type of the barcode is of a quadra-shape, and for binarizing the created gray barcode image when the determined type of barcode is of a linear shape. The barcode maintenance module 403i defines instructions, for example, for preserving a rest zone around the barcode, for preserving start points and end points of the barcode, for retaining the format and the shape of the barcode, for retaining the large amount of data in the barcode, etc.

The processor 501 of the computer system 500 employed by the image processing application 403 retrieves the instructions defined by the image acquisition module 403a, the barcode type determination module 403b, the scaling module 403c, the gray barcode creation module 403d, the grid size configuration module 403e, the modularization module 403f, the gray level intensity computation module 403g, the binarization module 403h, and the barcode maintenance module 403i of the image processing application 403, and executes the instructions.

At the time of execution, the instructions stored in the instruction register are examined to determine the operations to be performed. The processor 501 then performs the specified operations. The operations comprise arithmetic operations and logic operations. The operating system performs multiple routines for performing a number of tasks required to assign the input devices 507, the output devices 510, and memory for execution of the modules, for example, 403a, 403b, 403c, 403d, 403e, 403f, 403g, 403h, 403i, etc., of the image processing application 403. The tasks performed by the operating system comprise, for example, assigning memory to the modules, for example, 403a, 403b, 403c, 403d, 403e, 403f, 403g, 403h, 403i, etc., of the image processing application 403, and data, moving data between the memory unit 502 and disk units, and handling input/output operations. The operating system performs the tasks on request by the operations and after performing the tasks, the operating system transfers the execution control back to the processor 501. The processor 501 continues the execution to obtain one or more outputs. The outputs of the execution of the modules 403a, 403b, 403c, 403d, 403e, 403f, 403g, 403h, 403i, etc., of the image processing application 403 are, for example, rendered to the barcode decoder 404.

Disclosed herein is also a computer program product comprising a non-transitory computer readable storage medium that stores computer program codes comprising instructions executable by at least one processor 501 of the computer system 500 for processing the captured image 401 of the barcode. The non-transitory computer readable storage medium is communicatively coupled to the processor 501. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 501, except for a transitory, propagating signal.

The computer program product disclosed herein comprises multiple computer program codes for processing the captured image 401 of the barcode. For example, the computer program product disclosed herein comprises a first computer program code for acquiring a low quality captured image 401 of the barcode of any type and comprising a large amount of data; a second computer program code for determining the type of the barcode in the acquired image of the barcode; a third computer program code for creating a gray barcode image from the acquired image of the barcode, by gray shading over an entirety of the acquired image of the barcode; a fourth computer program code for modularizing the created gray barcode image based on the determined type of barcode; and a fifth computer program code for binarizing the created gray barcode image based on the determined type of the barcode by comparing the computed average gray level intensity of each of the grids of pixels in the created gray barcode image with the predetermined threshold depending on the determined type of the barcode or by comparing the computed gray level intensity of each of the pixels in the created gray barcode image with the predetermined threshold depending on the determined type of the barcode.

In an embodiment, the computer program product disclosed herein further comprises a sixth computer program code for optionally scaling the entirety of the acquired image of the barcode to create a scaled image of the barcode prior to the creation of the gray barcode image. In this embodiment, the third computer program code performs gray shading over an entirety of the scaled image of the barcode. The computer program product disclosed herein further comprises additional computer program codes for performing additional steps that may be required and contemplated for processing the captured image 401 of the barcode. In an embodiment, a single piece of computer program code comprising computer executable instructions performs one or more steps of the computer implemented method disclosed herein for processing the captured image 401 of the barcode.

The computer program codes comprising the computer executable instructions are embodied on the non-transitory computer readable storage medium. The processor 501 of the computer system 500 retrieves these computer executable instructions and executes them. When the computer executable instructions are executed by the processor 501, the computer executable instructions cause the processor 501 to perform the method steps for processing the captured image 401 of the barcode.

For purposes of illustration, the detailed description refers to the image processing application 403 disclosed herein being run locally on the computer system 500; however the scope of the computer implemented method and system 400 disclosed herein is not limited to the image processing application 403 being run locally on the computer system 500 via the operating system and the processor 501 but may be extended to run remotely over the network 405, for example, by employing a web browser and a remote server, a mobile phone, or other electronic devices.

FIG. 6 exemplarily illustrates an algorithm for processing quadra-shaped barcodes. This algorithm exemplarily illustrated in FIG. 6 comprises instructions defined by the image processing application 403 exemplarily illustrated in FIG. 4. This algorithm is herein referred to as a “grid image processor algorithm”. The algorithm is implemented by a subroutine herein referred to as a “GridImageProcessor( ) subroutine. The image processing application 403 converts an acquired input image to a buffered image. The generated images, for example, the scaled image, the created gray barcode image, and the final black and white image are buffered images. A buffered image is an image type that allows greater functionalities during processing than an ordinary image.

The image processing application 403 performs image processing over the entirety of the acquired image containing the barcode, for example, over the entire sheet of the acquired image containing the barcode, rather than processing only a part of the sheet that contains the barcode image. By processing over the entirety of the acquired image, the image processing application 403 preserves the rest zone of the barcode, preserves the “start” points and “end” points of the barcode, preserves the format of the barcode for eliminating distortion of the barcode format, and preserves the data encoded in the barcode for eliminating corruption of the data.

On acquiring the captured image 401, the image processing application 403 determines whether scaling is needed. If scaling is needed, the image processing application 403 scales the acquired photo-image and creates a gray barcode image from the scaled image. If scaling is not needed, the image processing application 403 directly creates a gray barcode image from the acquired photo-image. In the created gray barcode image, the three primary color components, for example, the red, green, and blue (RGB) components are the same with equal intensities. The uni-color component Lambda in the gray barcode image is represented as:

Lambda=red_component=green_component=blue_component

The image processing application 403 computes a hexadecimal value of a gray component in the gray barcode image as follows:

Gray component=(rgb_value_of pixel) & (Lambda), where “&” is a bitwise AND operator.

The image processing application 403 computes a color value “C” which is an integer value in the range of 0-255 as follows:

Color value C=(Gray component)>>16 (hex_base), where “>>” is a right shift operator.

For modularization and binarization, considering “C” as the color value computed above, “i” as an X axis position of a current pixel, and “j” as a Y axis position of the current pixel, the image processing application 403 computes the average color value of the grid as follows:

Average color value=[C(i)(j)+C(i)(j+1)+C(i)(j+2)+C(i+1)(j)+C(i+1)(j+1)+C(i+1)(j+2)+C(i+2)(j)+C(i+2)(j+1)+C(i+2)(j+2)]/9

The average color value is compared with a predetermined threshold to fill the grid with either black pixels or white pixels based on the comparison. The predetermined threshold is, for example, 100 which corresponds to about 40% of 256 (0-255), where black corresponds to 0 and white corresponds to 255. If the average color value is less than the predetermined threshold of, for example, 100 (about 40% of 256 (0-255)), the image processing application 403 sets the grid color to “black” pixel by pixel; else the image processing application 403 sets the grid color to “white” pixel by pixel. For quadra-shaped barcodes that are formatted to be bidirectional and that support a large amount of data, the image processing application 403 processes the captured image 401 in a modular fashion, that is, the image processing application 403 processes grids or groups of pixels rather than processing each pixel.

Modularization helps gain control of determining the appropriate color value or the gray level intensity for each pixel in the grid. Modularization considers the effect or the impact of all the immediate neighboring pixels for computation, in addition to the gray level intensity of the pixel being considered, which helps gain control at the pixel level to process the captured image 401 of a complex barcode, that is, a barcode with a large amount of data. This helps to virtually remove the blur in the captured image 401 of the barcode. The grid size for modularization is, for example, set to 3*3 pixels to enable efficient processing of a complex barcode having a large amount of data. This grid size helps virtually remove blur around a pixel.

If the grid size is less than 3, then the effect of all the immediate neighboring pixels on the pixel will not be considered. If the grid size is greater than 3, then the pixel level control will be lost. As used herein, the term “pixel level control” refers to the control established on the characteristics of each pixel in the captured image 401 of the barcode for determining its color value, having considered the effect or impact of all its immediate neighboring pixels on the pixel being considered. That is, even though modularization involves a grid or a group of pixels, the image processing application 403 controls and manipulates the characteristics of each pixel for improved processing of the photo-image 401 of the barcode with no loss of data encoded in the barcode. Also, since the input image is a captured image 401 of the barcode and is not a soft copy, predicting the average color value for the entire image as a whole yields inaccurate processing for barcodes with large data due to factors such as improper lighting, skew, etc., present in the entire image that dynamically alter a color shade of the captured image 401 of the complex barcode with large data. Therefore, the image processing application 403 considers a grid size equal to 3 which considers the effect of all the immediate neighboring pixels while maintaining the pixel level control.

FIG. 7 exemplarily illustrates an algorithm for processing linear shaped barcodes. This algorithm exemplarily illustrated in FIG. 7 comprises instructions defined by the image processing application 403 exemplarily illustrated in FIG. 4. The algorithm is implemented by a subroutine herein referred to as a “SimplelmageProcessor( )” subroutine. The image processing application 403 first converts an acquired input image of a barcode to one or more buffered images as disclosed in the detailed description of FIG. 6. The image processing application 403 performs image processing over the entirety of the acquired input image as disclosed in the detailed description of FIG. 6.

On acquiring the captured image 401, the image processing application 403 determines whether scaling is needed. If scaling is needed, the image processing application 403 scales the acquired photo-image and creates a gray barcode image from the scaled image. If scaling is not needed, the image processing application 403 directly creates a gray barcode image from the acquired photo-image. For linear shaped barcodes, the individual pixels in the gray barcode image are binarized without modularization to yield the final processed image. The binarization of the gray barcode image comprises computing the color value of each individual pixel in the gray barcode image and comparing the computed color value with a predetermined threshold, for example, 100, that is, about 40% of 256 (0-255), to replace the individual pixel with either a black pixel or a white pixel based on the comparison. If the color value is less than the predetermined threshold of 100 (about 40% of 256 (0-255)), the image processing application 403 replaces the individual pixel with a “black” pixel; else the image processing application 403 replaces the individual pixel with a “white” pixel.

For linear shaped barcodes that are formatted to be unidirectional, the image processing application 403 processes the acquired image in a linear fashion, that is, on a pixel by pixel basis. For linear shaped barcodes, modularization may have the risk of corrupting the standard format and the data of the barcode.

FIG. 8A exemplarily illustrates a pixel-level input image of a quadra-shaped barcode. As exemplarily illustrated in FIG. 8A, the input image is the entire sheet containing a two-dimensional barcode, and is represented by a matrix of m*n pixels. FIG. 8B exemplarily illustrates a scaled image of the quadra-shaped barcode. FIG. 8C exemplarily illustrates a 3*3 grid in the input image of the quadra-shaped barcode. Each pixel in the grid is composed of red, green and blue (RGB) color components. FIG. 8C exemplarily illustrates the RGB color components of each pixel in the 3*3 grid in the input image, where the RGB color components of each pixel are of different color intensities. FIG. 8D exemplarily illustrates a grid in a gray barcode image of the quadra-shaped barcode, showing the gray level intensity of each of the pixels in the grid. The RGB color components of each pixel in the grid in the gray barcode image are of the same color intensity, that is, R=G=B=lambda. Based on the intensity levels of the RGB values, the gray level intensity of each of the pixels in the grid varies as exemplarily illustrated in FIG. 8D. FIGS. 8E-8F exemplarily illustrate binarized grids generated based on a comparison of a computed average gray level intensity of a grid in the gray barcode image of a quadra-shaped barcode, with a predetermined threshold. The image processing application 403 exemplarily illustrated in FIG. 4 determines and compares the average gray level intensity of each grid with the threshold. The color value of each of the pixels in the binarized grid is 0 for a black grid and 255 for a white grid. If the average gray level intensity of the grid is, for example, within 100 (40% of 256 (0-255)), the resulting grid is a black grid in the binarized gray barcode image as exemplarily illustrated in FIG. 8E, where all the pixels in the grid have a color value of zero. If the average gray level intensity of the grid is, for example, about 100 (40% of 256 (0-255)) and above, the resulting grid is a white grid in the binarized gray barcode image as exemplarily illustrated in FIG. 8F, where all the pixels in the grid have a color value of 255.

FIG. 9A exemplarily illustrates a pixel-level input image of a linear shaped barcode. As exemplarily illustrated in FIG. 9A, the input image is the entire sheet containing a one-dimensional barcode, and is represented by a matrix of m*n pixels. FIG. 9B exemplarily illustrates a scaled image of a linear shaped barcode. FIG. 9C exemplarily illustrates a pixel in the input image of a linear shaped barcode, showing the red, green and blue (RGB) color components of the pixel, where the RGB color components are of different color intensities. FIG. 9D exemplarily illustrates a pixel in a gray barcode image of a linear shaped barcode, showing the RGB color components of the pixel, where the RGB color components are of the same color intensity, that is, R=G=B=Lambda.

FIGS. 9E-9F exemplarily illustrate binarized pixels generated based on a comparison of a computed gray level intensity of a pixel in the gray barcode image of the linear shaped barcode with a predetermined threshold. The RGB intensity levels of each pixel determine the gray level intensity of the pixel. The image processing application 403 exemplarily illustrated in FIG. 4 determines and compares the gray level intensity of each pixel with the threshold. The color value of each binarized pixel is 0 for a black pixel and 255 for a white pixel. If the gray level intensity of the pixel is, for example, within 100 (40% of 256 (0-255)), the resulting pixel is a black pixel having a color value of zero in the binarized gray barcode image as exemplarily illustrated in FIG. 9E. If the gray level intensity of the pixel is, for example, about 100 (40% of 256 (0-255)) and above, the resulting pixel is a white pixel having a color value of 255 in the binarized gray barcode image as exemplarily illustrated in FIG. 9F.

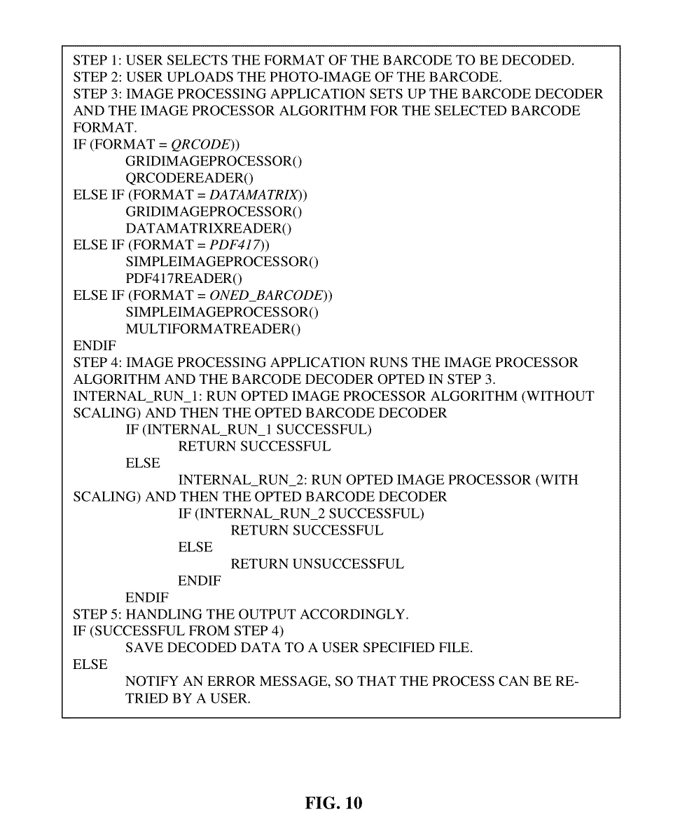

FIG. 10 exemplarily illustrates an algorithm for processing a captured image 401 of a barcode for a selected barcode format. The algorithm exemplarily illustrated in FIG. 10 comprises instructions defined by the image processing application 403 exemplarily illustrated in FIG. 4. A user selects the format of the barcode to be decoded, and uploads the captured image 401 or photo-image of the barcode. The image processing application 403 sets up the barcode decoder 404, for example, a zebra crossing (ZXing) decoder and applies the image processor algorithm based on a selected barcode format as disclosed in the detailed description of FIG. 6 and FIG. 7. For example, if the barcode format selected by the user is a quick response (QR) code format or a data matrix code format, the image processing application 403 is configured to pass control to a subroutine GridlmageProcessor( ) exemplarily illustrated in FIG. 6. After the execution of the GridlmageProcessor( ) subroutine, control is returned to an appropriate subroutine of an appropriate 2D barcode decoder 404, that is, the control is returned to a QR code reader for the QR code or a data matrix code reader for the data matrix code.

If the barcode format selected by the user is a portable data file 417 (PDF417) barcode format or a 1D barcode format, the image processing application 403 is configured to pass the control to the subroutine SimplelmageProcessor( ) exemplarily illustrated in FIG. 7. After the execution of the SimplelmageProcessor( ) subroutine, control is returned to an appropriate subroutine of an appropriate barcode decoder 404, that is, the control is returned to a PDF417 reader for the PDF417 barcode or a multi-format reader for the 1D barcode. The image processing application 403 runs the opted image processor algorithm and the opted barcode decoder 404. In the first run, the image processing application 403 executes the image processor algorithm without scaling and then runs the opted barcode decoder 404. If the execution fails, the image processing application 403 executes the image processor algorithm with scaling and then runs the opted barcode decoder 404. If any of the executions is successful, the image processing application 403 saves the decoded data to a user specified file. If all the executions are unsuccessful, the image processing application 403 notifies the user via an error message and prompts the user to retry the process.

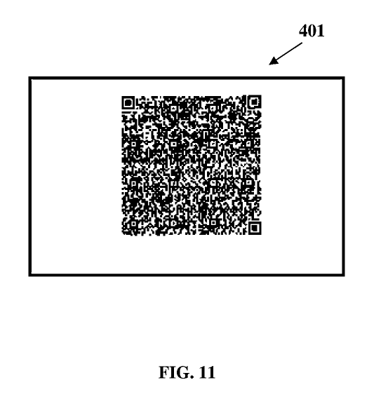

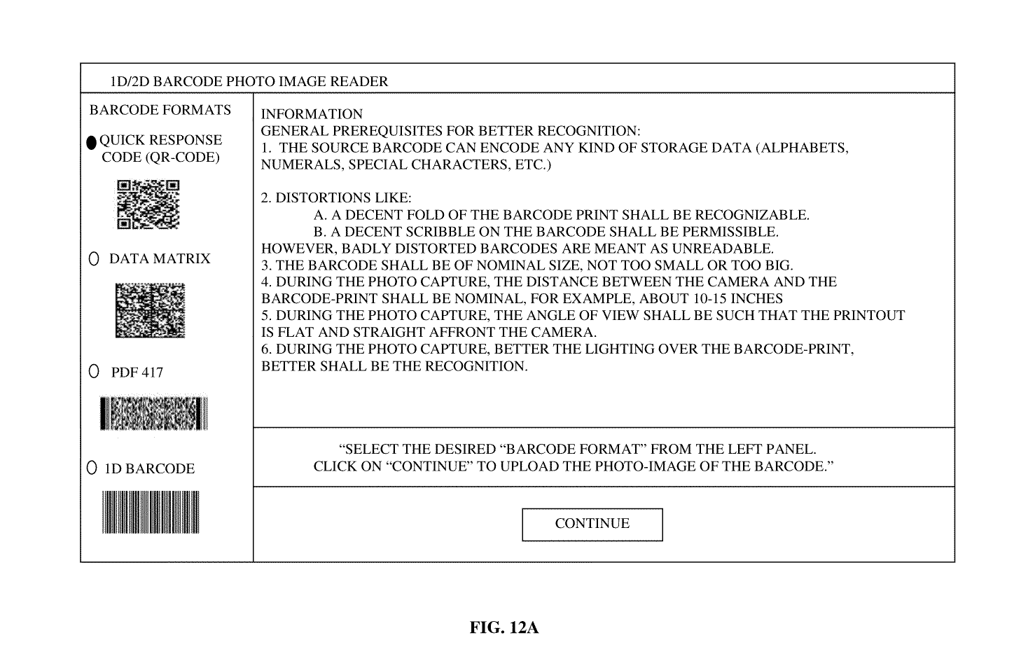

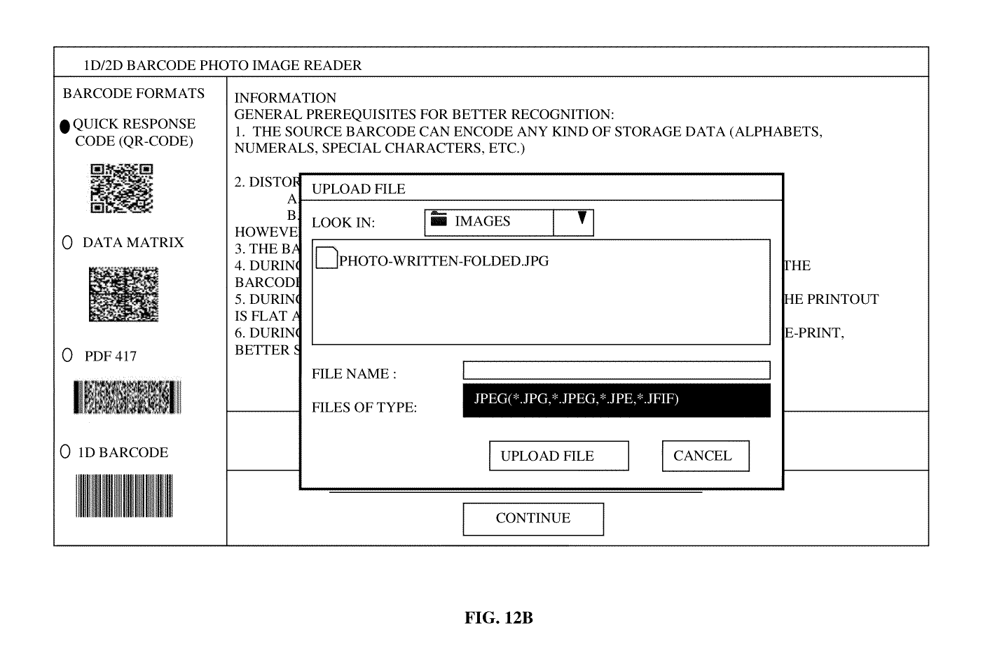

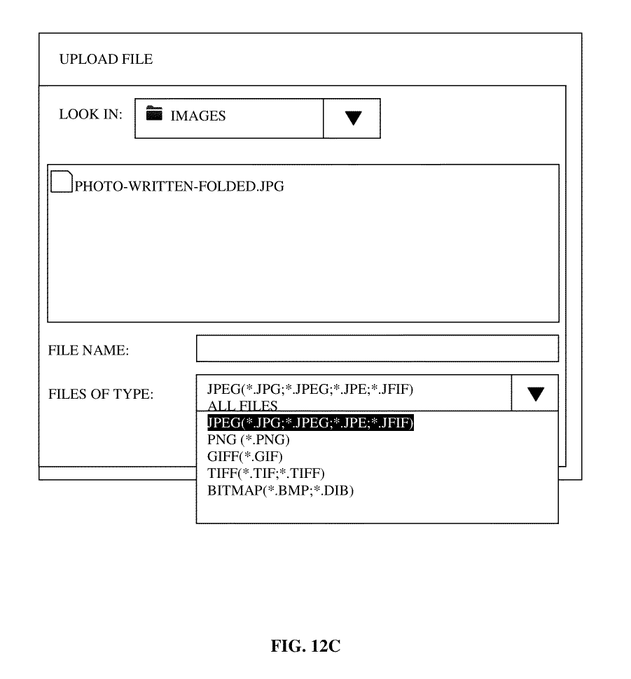

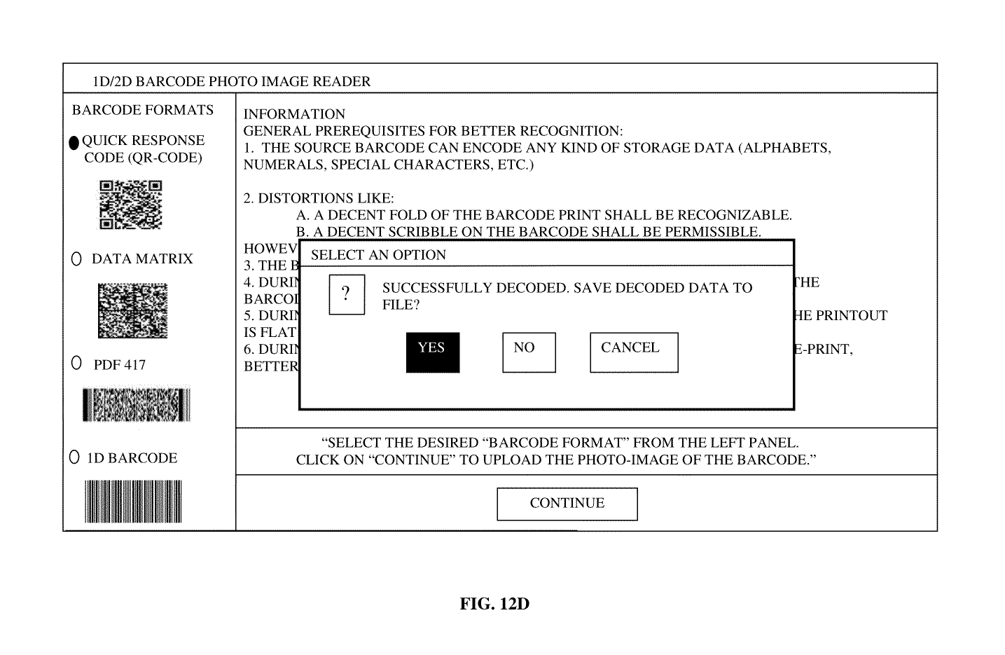

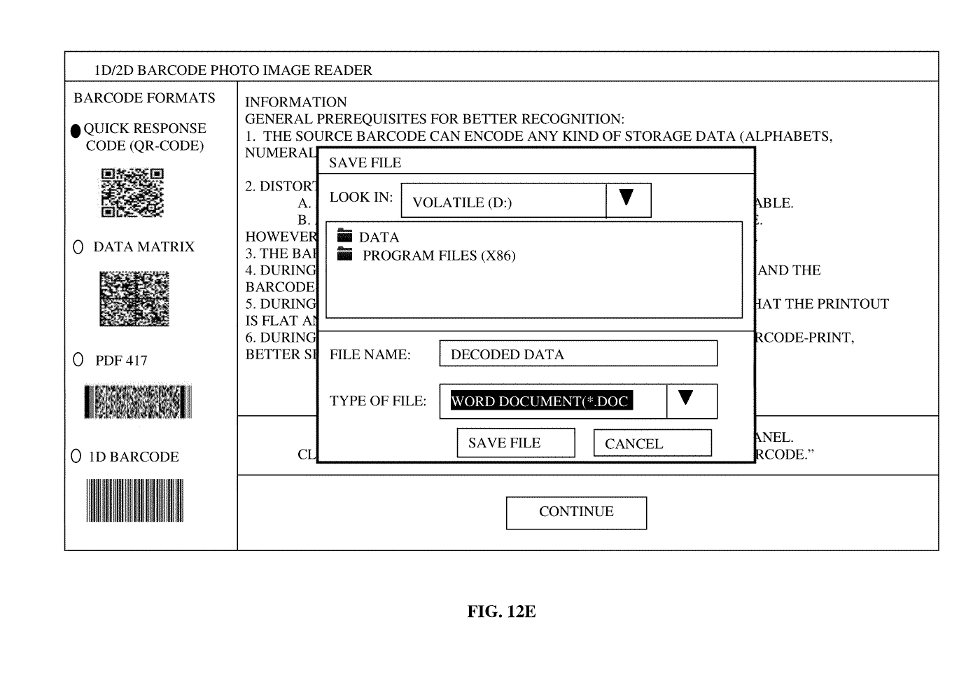

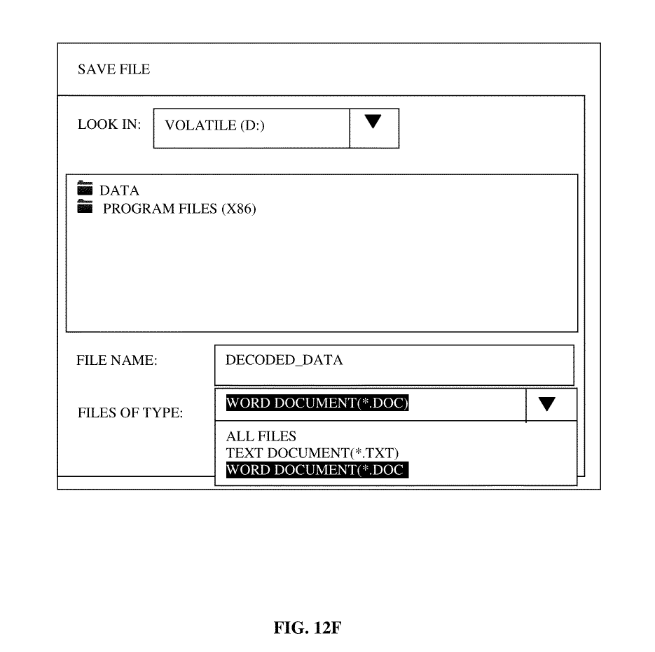

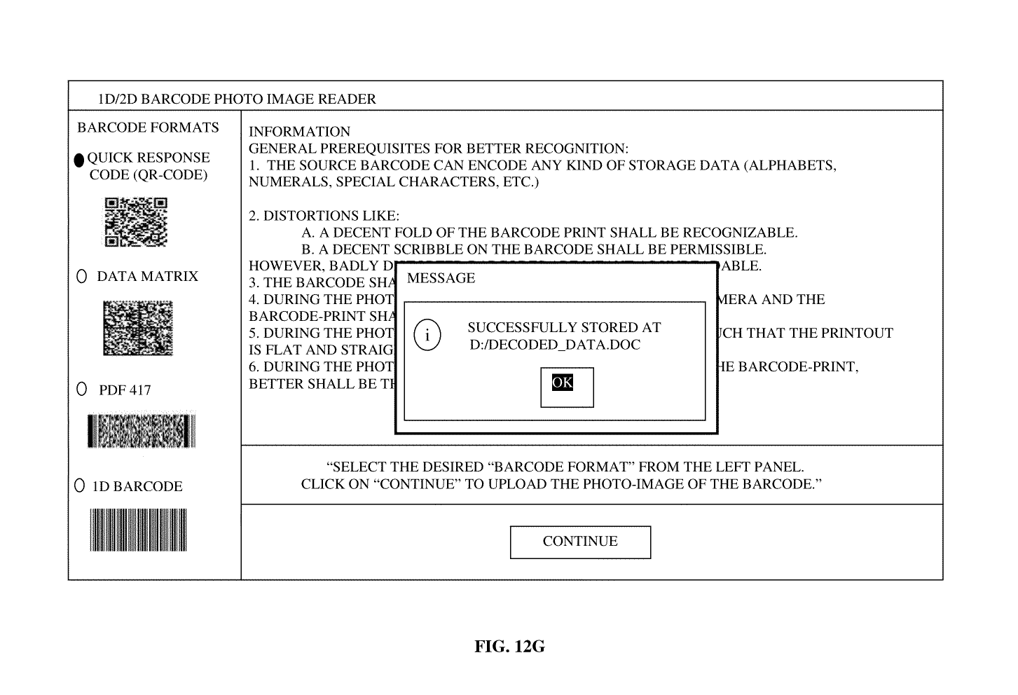

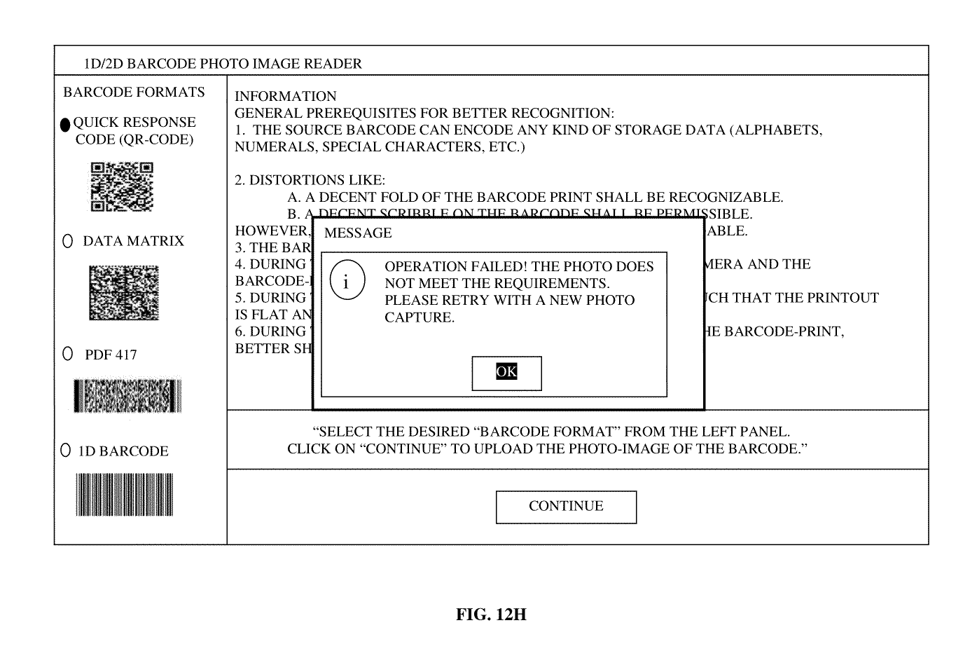

Consider an example where an input image 401 comprising a quick response (QR) code with low image quality and a large amount of encoded data is taken up for processing according to the computer implemented method disclosed herein. FIG. 11 exemplarily illustrates a captured image 401, also referred to herein as a “photo-image”, of a quick response (QR) code with low image quality and a large amount of encoded data. The input photo-image 401 may be locally stored on a user's computing device 402 or on a networked computing device 402 exemplarily illustrated in FIG. 4. The user launches the image processing application 403 on the computing device 402 which loads a graphical user interface (GUI) as exemplarily illustrated in FIG. 12A.

FIGS. 12A-12H exemplarily illustrate screenshots of the graphical user interface (GUI) provided by the image processing application 403, exemplarily illustrated in FIG. 4, for processing the captured image 401 of the barcode according to the computer implemented method disclosed herein. The GUI exemplarily illustrated in FIG. 12A provides the user with options to select the barcode format of the input photo-image 401. The user may select one of the associated radio buttons on a left hand panel of the GUI to select the barcode format. The right hand panel of the GUI screen provides information on the general prerequisites for better barcode recognition. For example, an information screen of the GUI displays information related to the acceptable types of storage data, for example, alphabets, numerals, special characters encoded in the source barcode, etc., acceptable distortions in the barcode print such as a decent fold or a decent scribble, etc., the acceptable size of the barcode, the desired distance between the camera that captured the image 401 of the barcode and the barcode print, the angle of view during capture of the image 401 of the barcode, the lighting conditions, etc.

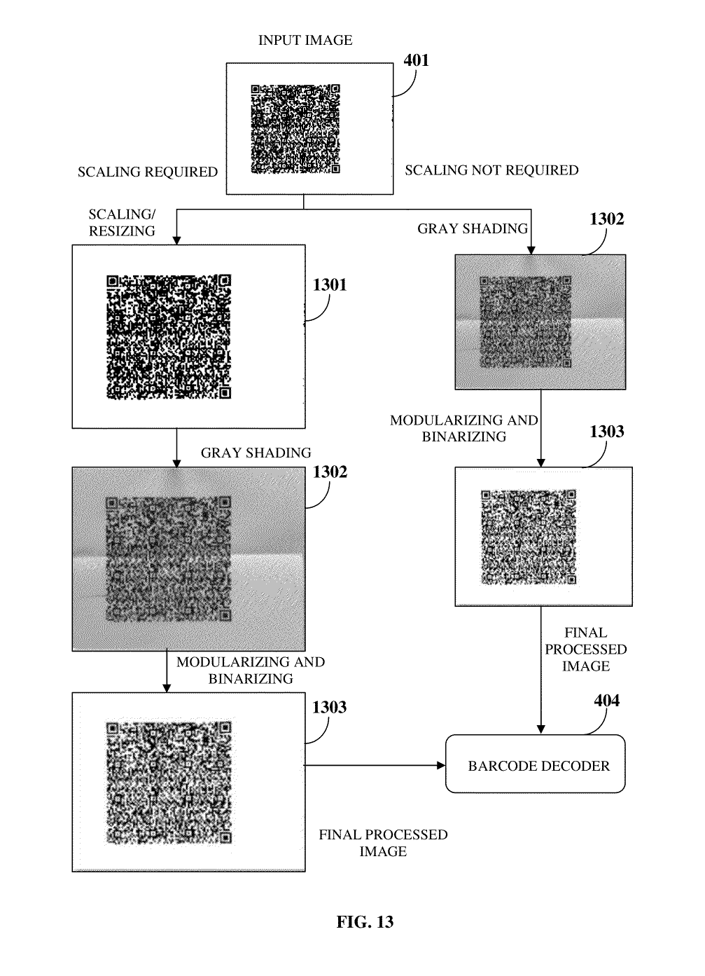

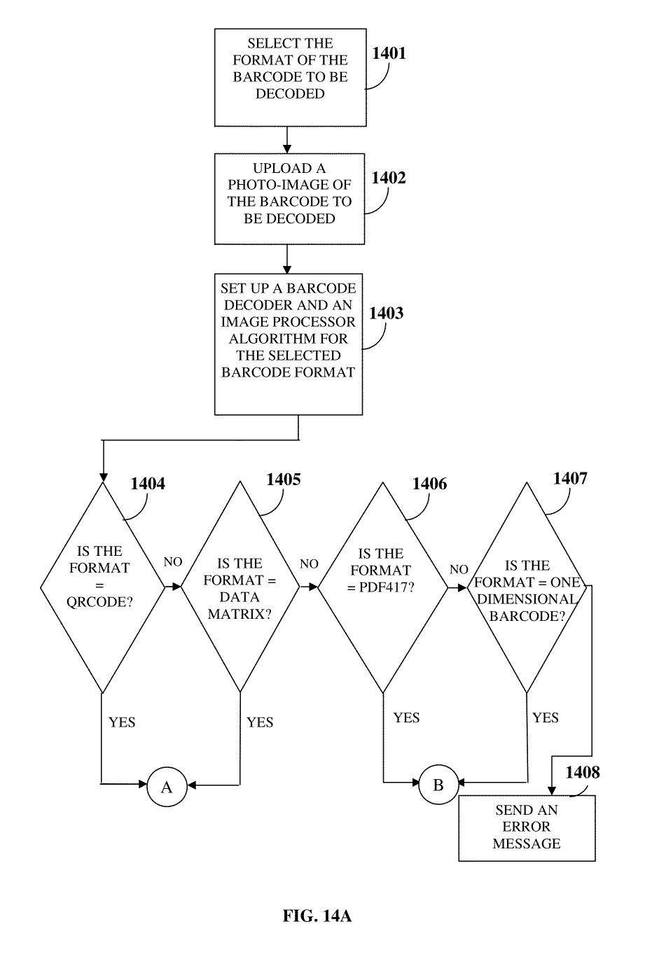

After selecting the barcode format of the input photo-image 401, the user clicks “Continue” and an “Upload File” dialog box opens as exemplarily illustrated in FIG. 12B. FIGS. 12B-12C exemplarily illustrate the GUI for uploading the input photo-image 401 of the barcode. The user can browse and upload the input photo-image 401 of any standard image file format from a local hard drive on the user's computing device 402 or over a network 405, as exemplarily illustrated in FIG. 12C. For example, the standard image file formats supported by the image processing application 403 comprise, for example, JPG, JPE, JFIF, JPEG, PNG, GIF, TIF, TIFF, etc., and bitmap formats, for example, BMP, DIB, etc. The image processing application 403 acquires the input photo-image 401 and processes the input photo-image 401 as disclosed in the detailed description of FIG. 13. When the barcode is successfully processed and read, the image processing application 403 prompts the user to save the decoded data to a file, as exemplarily illustrated in FIG. 12D. As exemplarily illustrated in FIG. 12E, the image processing application 403 saves the decoded data to a user defined file, for example, a text file. The image processing application 403 supports various text file formats comprising, for example, .txt, .doc, etc., for saving the decoded data. The image processing application 403 displays a “Save File” dialog box to the user on the GUI for saving the decoded data as exemplarily illustrated in FIG. 12F. The image processing application 403 then notifies the user that the decoded data is successfully stored at the user specified location, as exemplarily illustrated in FIG. 12G. If the recognition of the barcode data is unsuccessful, the image processing application 403 notifies the user accordingly via the GUI, and prompts the user to retry again with a new photo-image 401 of the barcode, as exemplarily illustrated in FIG. 12H.

FIG. 13 exemplarily illustrates image-by-image processing of a captured image 401 of a complex barcode for subsequent decoding of the processed barcode. The captured image 401 is herein referred to as a “photo-image”. The time required to process the input photo-image 401, obtain a final processed image 1303 for decoding, and decode the final processed image 1303 is, for example, less than a second, resulting in a time efficient process. Depending on whether scaling is required, the image processing application 403, exemplarily illustrated in FIG. 4, scales or resizes the input photo-image 401 and gray shades the scaled image 1301 or the original image 401 to create a gray barcode image 1302. The gray barcode image 1302 of a two dimensional barcode, according to this example, is then modularized and binarized to yield the final processed image 1303. The final processed image 1303 is fed to the barcode decoder 404 for decoding the data in the barcode.

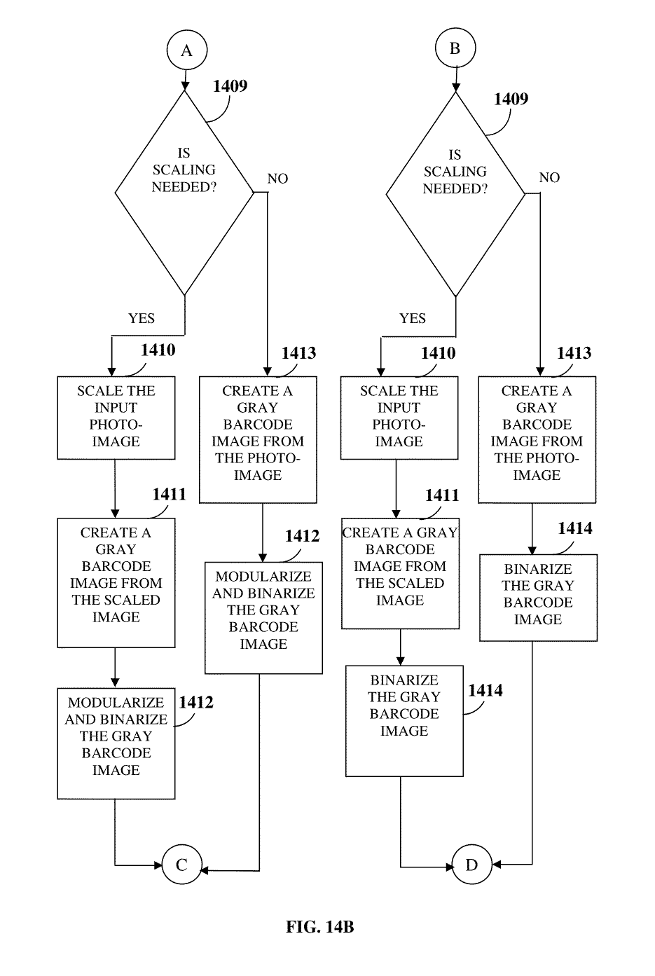

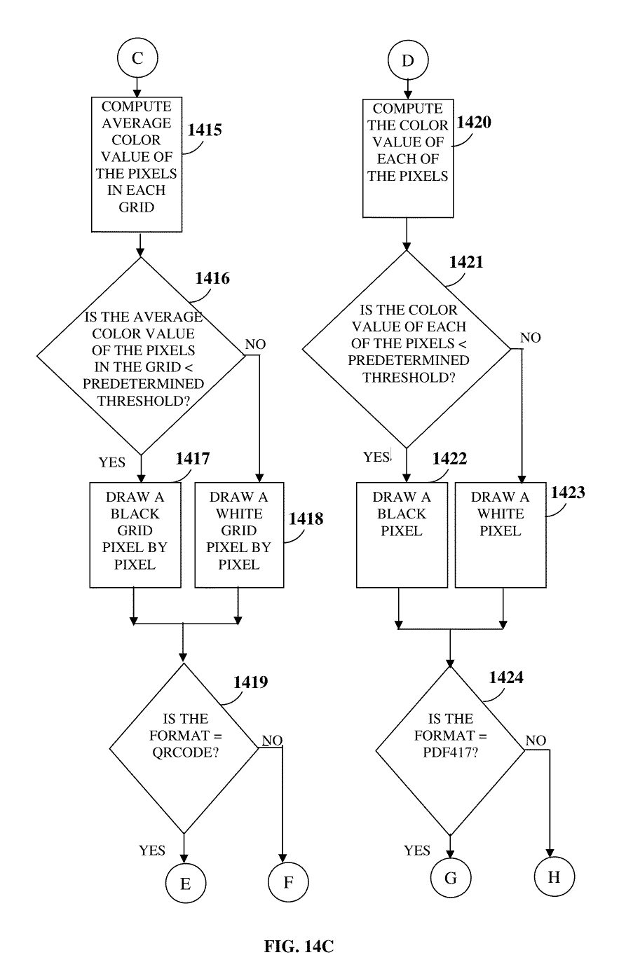

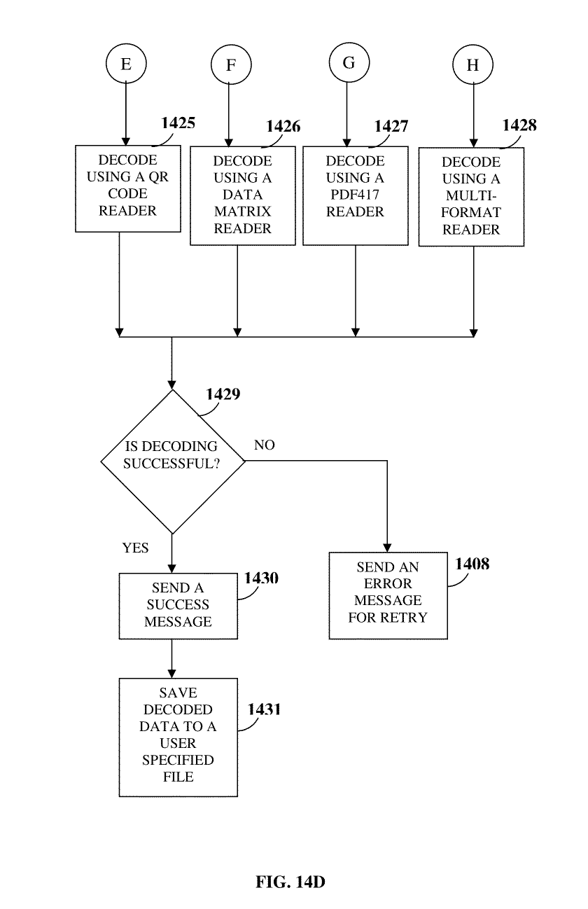

FIGS. 14A-14D exemplarily illustrate a flow chart comprising the steps for processing the captured image 401 herein also referred to as a “photo-image” of a barcode. Consider an example where the image processing application 403, exemplarily illustrated in FIG. 4, is provided on a computing device 402, for example, a personal computer. The image processing application 403 provides a “barcode format selection menu” on a graphical user interface (GUI) that allows a user to select 1401 the format of the barcode to be decoded. The user uploads 1402 the photo-image 401 of the barcode to be decoded to the image processing application 403. The image processing application 403 on the personal computer 402 sets up 1403 a barcode decoder 404 exemplarily illustrated in FIG. 4 and an image processor algorithm as exemplarily illustrated in FIG. 6 and FIG. 7 for the selected barcode format. The image processing application 403 executes the image processor algorithm to generate the final processed image 1303 exemplarily illustrated in FIG. 13. The image processing application 403, for example, converts the photo-image 401 to buffered images as disclosed in the detailed description of FIG. 6 and FIG. 7. The image processing application 403 checks 1404 whether the format of the barcode is of a quick response (QR) code. If the format of the barcode is of a QR code, the image processing application 403 checks 1409 whether the photo-image 401 of the QR code needs to be scaled. If scaling is needed, the image processing application 403 scales 1410 the photo-image 401, creates 1411 a gray barcode image 1302 from the scaled image 1301 as exemplarily illustrated in FIG. 13, and then modularizes and binarizes 1412 the gray barcode image 1302. If the image processing application 403 determines that the format of the barcode is of a QR code and that scaling is not needed, the image processing application 403 creates 1413 a gray barcode image 1302 directly from the captured photo-image 401, and then modularizes and binarizes 1412 the gray barcode image 1302.

If the image processing application 403 determines that the selected barcode format is not a QR code, the image processing application 403 checks 1405 whether the selected barcode format is a data matrix format. If the image processing application 403 determines that the format of the barcode is a data matrix format, then the image processing application 403 checks 1409 if scaling is needed for the photo-image 401 of the barcode. If scaling is needed, the image processing application 403 scales 1410 the photo-image 401, creates 1411 a gray barcode image 1302 from the scaled image 1301, and modularizes and binarizes 1412 the gray barcode image 1302. If the image processing application 403 determines that scaling is not needed, the image processing application 403 creates 1413 a gray barcode image 1302 directly from the photo-image 401, and modularizes and binarizes 1412 the gray barcode image 1302.

If the format of the barcode is not a data matrix format, the image processing application 403 checks 1406 whether the format of the barcode is a PDF417 format. If the format of the barcode is a PDF417 format, the image processing application 403 checks 1409 whether scaling of the barcode image 401 is needed. If scaling is needed, the image processing application 403 scales 1410 the input photo-image 401, creates 1411 a gray barcode image 1302 from the scaled image 1301, and binarizes 1414 the gray barcode image 1302. If the image processing application 403 determines that the scaling is not needed, the image processing application 403 creates 1413 a gray barcode image 1302 directly from the captured photo-image 401 and binarizes 1414 the gray barcode image 1302. Furthermore, if the format of the barcode is not a PDF417 format, the image processing application 403 checks 1407 whether the format of the barcode matches that of a one-dimensional barcode. If the format of the barcode matches that of a one-dimensional barcode, the image processing application 403 checks 1409 whether scaling of the photo-image 401 is needed. If scaling is needed, the image processing application 403 scales 1410 the input photo-image 401, creates 1411 a gray barcode image 1302 from the scaled image 1301, and binarizes 1414 the gray barcode image 1302. If the scaling is not needed, then the image processing application 403 creates 1413 a gray barcode image 1302 directly from the captured photo-image 401 and binarizes 1414 the gray barcode image 1302. If the format of the barcode matches none of the specified barcode formats, the image processing application 403 sends 1408 an error message to the user and requests the user to retry.

Based on the selected type of the barcode format, the image processing application 403 computes either an average color value of pixels in each grid or individual color values of the pixels. When the selected type of the barcode format is a quadra-shaped barcode, for example, in the case of QR barcodes and data matrix barcodes, the image processing application 403 computes 1415 the average color value of the pixels in each grid. The image processing application 403 then checks 1416 whether the average color value of the pixels in the grid is less than a predetermined threshold of 100, in this example. For example, if the average color value of pixels in the grid is less than 100, the image processing application 403 draws 1417 a black grid pixel by pixel. If the average color value of pixels in the grid is greater than or equal to 100, the image processing application 403 draws 1418 a white grid pixel by pixel. The image processing application 403 checks 1419 whether the format of the barcode is a QR code format. If the format of the barcode is a QR code format, the image processing application 403 decodes 1425 the data from the output image, that is, the final processed image 1303 exemplarily illustrated in FIG. 13, using a QR code reader. The QR code reader is a subroutine of the barcode decoder 404, for example, a zebra crossing (ZXing) decoder. The QR code reader is set up when the image processor algorithm is set up based on the format of the barcode selected by the user. If the format of the barcode is not a QR code format, the image processing application 403 decodes 1426 the data from the output image using a data matrix reader. The data matrix reader is a subroutine of the barcode decoder 404, for example, the ZXing decoder. The data matrix reader is set up when the image processor algorithm is set up based on the format of the barcode selected by the user.

When the selected type of the barcode format is a linear shaped barcode as in the case of PDF417 barcodes and one dimensional barcodes, the image processing application 403 computes 1420 a color value of each of the pixels and checks 1421 whether the color value of each of the pixels is less than a predetermined threshold. If the color value of each of the pixels in the image of the PDF417 code is less than a predetermined threshold, for example, 100 (about 40% of 256 (0-255)) in this example, the image processing application 403 draws 1422 a black pixel. If the color value of each of the pixels is greater than or equal to 100 (about 40% of 256 (0-255)), the image processing application 403 draws 1423 a white pixel. The image processing application 403 checks 1424 whether the format of the barcode is PDF417. If the format of the barcode is PDF417, the image processing application 403 decodes 1427 the data from the output image using a PDF417 reader. The PDF417 reader is a subroutine of the barcode decoder 404, for example, the ZXing decoder. The PDF417 reader is set up when the image processor algorithm is set up based on the format of the barcode selected by the user. If the format of the barcode is not PDF417, the image processing application 403 decodes 1428 the data from the output image using a multi-format reader. The multi-format reader decodes one-dimensional barcodes. The multi-format reader is a subroutine of the barcode decoder 404, for example, the ZXing decoder. The multi-format reader is set up when the image processor algorithm is set up based on the format of the barcode selected by the user.

The image processing application 403 then checks 1429 whether the decoding of the barcode data is successful. If the format of the barcode is recognized and decoded correctly, then the image processing application 403 sends 1430 a success message to the user and saves 1431 the decoded data to a user specified file. If the decoding of the barcode data is unsuccessful, the image processing application 403 sends 1408 an error message and requests the user to retry.

The scope of the barcode is everywhere in today's market, as data is an integral part of the world. The elements, for example, low quality resistance, support for a large amount of data, support for multiple barcode formats, etc., makes the computer implemented method and system 400 exemplarily illustrated in FIG. 4 possess a vast scope of usage from home to industry. For example, any user may use the computer implemented method and system 400 disclosed herein to process barcodes that encode large amounts of confidential data. In another example, corporate industries may use the computer implemented method and system 400 disclosed herein at low cost without any need of additional hardware and software. The support for large data in a photo-image 401 of a barcode makes the computer implemented method and system 400 disclosed herein attain a wide scope from common man to corporate applications. The computer implemented method and system 400 disclosed herein supports any barcode decoder 404 and allows enhanced decoding by overcoming the limitations of image quality and amount of data of the barcode decoder 404. The support for large amount of data provided by the computer implemented method and system 400 disclosed herein prominently changes the role of barcodes in the present world. Barcodes are used as hard copies, that is, printed paper copies rather than soft copies. The recognition of a soft copy of a barcode image is different from the recognition of the photo-image or the captured image 401 of the hard copy of the barcode since the recognition of the photo-image or the captured image 401 of the hard copy of the barcode has to overcome the practical dependencies inherent during the photo capture of the barcode by a user. Adding more data to the barcode increases the complexity of such captured images 401. The computer implemented method and system 400 disclosed herein does not require purchase of additional hardware, for example, barcode scanners or software for processing a captured image 401 of a barcode, which makes the computer implemented method and system 400 disclosed herein cost effective. A few industrial applications of the computer implemented method and system 400 disclosed herein comprise, for example, barcode encoding and decoding of large user data by liquid petroleum gas (LPG) supply agencies, barcode encoding of data associated with electronic stamping by banks, encoding of information associated with income tax files or forms, etc.

The image processing application 403 of the computer implemented method and system 400 disclosed herein can be configured for enhanced accessibility to a common user. In an example, the image processing application 403 can be used to secure confidential data of the user. In another example, corporate industries can employ the image processing application 403 for storage and retrieval of large data at low cost for versatile reasons. Therefore, the computer implemented method and system 400 disclosed herein can be configured flexibly for multiple purposes.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises computer program codes for implementing the processes of various embodiments.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for processing a captured image of a barcode, said method employing a computer system comprising at least one processor communicatively coupled to a non-transitory computer readable storage medium that stores instructions executable by said at least one processor, said at least one processor configured to implement said method, said method comprising:
providing an image processing application on a computing device;
acquiring said captured image of said barcode by said image processing application, wherein said barcode is of a plurality of types and comprises a large amount of data, and wherein said captured image of said barcode is of low quality;
determining a type of said barcode in said acquired image of said barcode by said image processing application;
creating a gray barcode image from said acquired image of said barcode by said image processing application, by gray shading over an entirety of said acquired image of said barcode;
modularizing said created gray barcode image by said image processing application based on said determined type of said barcode; and
binarizing said created gray barcode image by said image processing application based on said determined type of said barcode by one of comparing an average gray level intensity of each of a plurality of grids of pixels in said created gray barcode image and comparing a gray level intensity of each of individual pixels in said created gray barcode image, with a predetermined threshold.

2. The computer implemented method of claim 1, further comprising scaling said entirety of said acquired image of said barcode by said image processing application to create a scaled barcode image prior to said creation of said gray barcode image, wherein said gray barcode image is created by gray shading over an entirety of said scaled barcode image.

3. The computer implemented method of claim 1, further comprising computing said gray level intensity of said each of said individual pixels in said created gray barcode image and comparing said computed gray level intensity with said predetermined threshold based on said determined type of said barcode by said image processing application, wherein said created gray barcode image is binarized by said image processing application based on said comparison of said computed gray level intensity of said each of said individual pixels in said created gray barcode image with said predetermined threshold depending on said determined type of said barcode.

4. The computer implemented method of claim 1, further comprising computing said average gray level intensity of each of said grids of said pixels in said created gray barcode image and comparing said computed average gray level intensity with said predetermined threshold based on said determined type of said barcode by said image processing application, wherein said created gray barcode image is binarized by said image processing application based on said comparison of said computed average gray level intensity of said each of said grids of said pixels in said created gray barcode image with said predetermined threshold depending on said determined type of said barcode.

5. The computer implemented method of claim 1, further comprising configuring a grid size for said modularization of said created gray barcode image based on predetermined criteria by said image processing application.

6. The computer implemented method of claim 1, wherein said captured image of said barcode is of said low quality with respect to image resolution, noise, and distortion.

7. The computer implemented method of claim 1, wherein said data in said barcode comprises one or more of textual content, image content, graphical content, and any combination thereof.

8. The computer implemented method of claim 1, wherein said type of said barcode comprises one of a shape of said barcode, a format of said barcode, and a combination thereof.

9. The computer implemented method of claim 8, wherein said shape of said barcode is one of a linear shape and a quadra-shape.

10. The computer implemented method of claim 8, wherein said format of said barcode is one of a one-dimensional barcode format and a two-dimensional barcode format.

11. The computer implemented method of claim 1, wherein said modularization of said created gray barcode image by said image processing application is performed when said determined type of said barcode is of a quadra-shape.

12. The computer implemented method of claim 1, wherein said image processing application binarizes said modularized gray barcode image when said determined type of said barcode is of a quadra-shape.

13. The computer implemented method of claim 1, wherein said image processing application binarizes said created gray barcode image when said determined type of said barcode is of a linear shape.

14. The computer implemented method of claim 1, further comprising preserving a rest zone around said barcode by said image processing application during said modularization and said binarization of said created gray barcode image over said entirety of said created gray barcode image.

15. The computer implemented method of claim 1, further comprising preserving start points and end points of said barcode by said image processing application during said modularization and said binarization of said created gray barcode image over said entirety of said created gray barcode image.

16. The computer implemented method of claim 1, further comprising retaining a format and a shape of said barcode by said image processing application for reducing distortion of said format and said shape of said barcode.

17. The computer implemented method of claim 1, further comprising retaining said large amount of said data in said barcode by said image processing application for preventing corruption of said large amount of said data in said barcode.

18. A computer implemented system for processing a captured image of a barcode, said computer implemented system comprising:
at least one processor;
a non-transitory computer readable storage medium communicatively coupled to said at least one processor, said non-transitory computer readable storage medium storing modules of an image processing application of said computer implemented system that are executable by said at least one processor, said image processing application comprising:
an image acquisition module that acquires said captured image of said barcode, wherein said barcode is of a plurality of types and comprises a large amount of data, and wherein said captured image of said barcode is of low quality;
a barcode type determination module that determines a type of said barcode in said acquired image of said barcode;
a gray barcode creation module that creates a gray barcode image from said acquired image of said barcode, by gray shading over an entirety of said acquired image of said barcode;
a modularization module that modularizes said created gray barcode image based on said determined type of said barcode; and
a binarization module that binarizes said created gray barcode image based on said determined type of said barcode by one of comparing an average gray level intensity of each of a plurality of grids of pixels in said created gray barcode image and comparing a gray level intensity of each of individual pixels in said created gray barcode image, with a predetermined threshold.

19. The computer implemented system of claim 18, wherein said image processing application further comprises a scaling module that scales said entirety of said acquired image of said barcode to create a scaled barcode image prior to said creation of said gray barcode image, wherein said gray barcode creation module creates said gray barcode image by gray shading over an entirety of said scaled barcode image.

20. The computer implemented system of claim 18, wherein said image processing application further comprises a gray level intensity computation module that computes said gray level intensity of said each of said individual pixels in said created gray barcode image, and compares said computed gray level intensity with said predetermined threshold based on said determined type of said barcode, wherein said binarization module binarizes said created gray barcode image based on said comparison of said computed gray level intensity of said each of said individual pixels in said created gray barcode image with said predetermined threshold depending on said determined type of said barcode.

21. The computer implemented system of claim 20, wherein said gray level intensity computation module computes an average gray level intensity of each of said grids of said pixels in said created gray barcode image and compares said computed average gray level intensity with said predetermined threshold based on said determined type of said barcode, wherein said binarization module binarizes said created gray barcode image based on said comparison of said computed average gray level intensity of said each of said grids of said pixels in said created gray barcode image with said predetermined threshold depending on said determined type of said barcode.

22. The computer implemented system of claim 18, wherein said image processing application further comprises a grid size configuration module that configures a grid size for said modularization of said created gray barcode image based on predetermined criteria.

23. The computer implemented system of claim 18, wherein said captured image of said barcode is of said low quality with respect to image resolution, noise, and distortion.

24. The computer implemented system of claim 18, wherein said data in said barcode comprises one or more of textual content, image content, graphical content, and any combination thereof.

25. The computer implemented system of claim 18, wherein said type of said barcode comprises one of a shape of said barcode, a format of said barcode, and a combination thereof, wherein said shape of said barcode is one of a linear shape and a quadra-shape, and wherein said format of said barcode is one of a one-dimensional barcode format and a two-dimensional barcode format.

26. The computer implemented system of claim 18, wherein said modularization module modularizes said created gray barcode image when said determined type of said barcode is of a quadra-shape.

27. The computer implemented system of claim 18, wherein said binarization module binarizes said modularized gray barcode image when said determined type of said barcode is of a quadra-shape, and wherein said binarization module binarizes said created gray barcode image when said determined type of said barcode is of a linear shape.

28. The computer implemented system of claim 18, wherein said image processing application further comprises a barcode maintenance module that performs:
preserving a rest zone around said barcode during said modularization and said binarization of said created gray barcode image over said entirety of said created gray barcode image;
preserving start points and end points of said barcode during said modularization and said binarization of said created gray barcode image over said entirety of said created gray barcode image;
retaining a format and a shape of said barcode for reducing distortion of said format and said shape of said barcode; and
retaining said large amount of said data in said barcode for preventing corruption of said large amount of said data in said barcode.

29. A computer program product comprising a non-transitory computer readable storage medium, said non-transitory computer readable storage medium storing computer program codes comprising instructions executable by at least one processor, said computer program codes comprising:
a first computer program code for acquiring a captured image of a barcode, wherein said barcode is of a plurality of types and comprises a large amount of data, and wherein said captured image of said barcode is of low quality;
a second computer program code for determining a type of said barcode in said acquired image of said barcode;
a third computer program code for creating a gray barcode image from said acquired image of said barcode, by gray shading over an entirety of said acquired image of said barcode;
a fourth computer program code for modularizing said created gray barcode image based on said determined type of said barcode; and
a fifth computer program code for binarizing said created gray barcode image based on said determined type of said barcode by comparing one of a computed average gray level intensity of each of a plurality of grids of pixels in said created gray barcode image and a computed gray level intensity of each of said pixels in said created gray barcode image with said predetermined threshold depending on said determined type of said barcode.

30. The computer program product of claim 29, further comprising a sixth computer program code for scaling said entirety of said acquired image of said barcode to create a scaled barcode image prior to said creation of said gray barcode image, wherein said third computer program code performs said gray shading over an entirety of said scaled barcode image.
